(19) United States
(12) Patent Application Publication
(10) Pub. No.: US 2020/0203675 A1
(43) Pub. Date: Jun. 25, 2020

(54) SECONDARY BATTERY WITH LONG CYCLE LIFE

(71) Applicant: AB SYSTEMS, INC. (US), Palo Alto, CA (US)

(72) Inventors: Meng-Chang LIN, Union City, CA (US); Meijie TANG, Cupertino, CA (US); Hongjie DAI, Cupertino, CA (US); Chun-Jern PAN, Union City, CA (US); Pengfei Ql, Union City, CA (US)

(21) Appl. No.: 16/604,020

(22) PCT Filed: Apr. 10, 2018
(86) PCT No.: PCT/US2018/026968

§ 371 Date: Oct. 9, 2019

Related U.S. Application Data
(60) Provisional application No. 62/483,830, filed on Apr. 10, 2017.

(51) Int. Cl. H01M 2/02; H01M 2/08; H01M 4/38; H01M 4/583; H01M 4/66

(52) U.S. Cl. CPC H01M 2/026; H01M 2/0262; H01M 2/08; H01M 4/38; H01M 4/583; H01M 2300/0002; H01M 4/661; H01M 2/024; H01M 2/0277; H01M 2/0285; H01M 2/0207; H01M 4/663

(57) ABSTRACT

Provided herein are new methods for making a highly stable metal anode (e.g., aluminum ion) battery. The battery includes, in some embodiments, a fluorinated material, for instance FEP or PTFE, as a chemical compatible enclosure which does not react with the electrolyte in the battery. In some examples, the batteries described herein are stable over many cycle lives and also tolerant a highly acidic electrolyte environment, even after long storage times. In some examples, the chemical compatible enclosure includes an inserted tube which allows for the removing of residual water and HCl which may be present in the battery, either as made, during use (e.g., charge-discharge cycling), or after use. Also set forth herein, in some examples, are methods of using a battery, including continuous drawing a vacuum on a battery during battery cycling.

### CROSS-REFERENCE TO RELATED APPLICATIONS

This application claims the benefit of U.S. Provisional Patent Application No. 62/483,830, filed Apr. 10, 2017, and titled BATTERY WITH LONG CYCLE LIFE, the entire contents of which are herein incorporated by reference in its entirety for all purposes.

### FIELD

The present disclosure concerns rechargeable (i.e., secondary) batteries as well as methods of making and using the same. In some examples, the present disclosure concerns rechargeable batteries such as, but not limited to, rechargeable batteries having an aluminum (Al) metal anode (i.e., negative electrode).

### BACKGROUND

A battery's energy density is related to the electrochemical potential difference for an atom (e.g., Li) in the anode relative to the corresponding ion (e.g., Li⁺) in the cathode. A rechargeable battery's energy density is therefore maximized when the anode is a single metal. The electrochemical potential for a metal atom in a metal made of identical atoms is 0 V. Thus, metal anodes as compared to intercalation anodes (e.g., Li₆C or lithium titanate) maximize the energy difference between the anode and any cathode. Therefore, to increase the energy density of current batteries, as well as for safety and economic reasons, metal anode rechargeable batteries are desired but not yet commercially available.

Aluminum (Al) is an attractive metal for a metal anode rechargeable battery. The three-electron redox properties of Al provides a theoretical gravimetric capacity as high as 2,980 mAh/g and a volumetric capacity as high as 804 Ah cm⁻³, when paired with a carbon-containing cathode. Al is also the third most abundant element in the Earth's crust. Al is generally less reactive than other metal anodes (e.g., lithium (Li) and sodium (Na)) and is easier to process. Al is therefore an economically viable choice for large scale battery manufacturing and, for example, grid storage applications.

Key to commercializing Al-metal anode rechargeable batteries, is the development of electrolytes which are chemically compatible with Al and which are sufficiently ionically conductive. Also critical is the development of packaging materials which can enclose an Al-metal anode rechargeable battery and its electrolyte without corroding the battery and degrading electrochemical performance. Some researchers have developed Al-metal anode rechargeable batteries and used electrolytes which included ionic liquid electrolyte (ILE) mixtures of AlCl₃ and 1-ethyl-3-methylimidazolium chloride ([EMIm]Cl) or AlCl₃ and urea. See, for example, US Patent Application Publication No. 2015-0249261; Lin, M-C, et al., Nature, 2015, p. 1-doi:1038/nature143040; and Angell, et al., PNAS, Early Edition, 2016, p. 1-6, doi:10.1073/pnas.1619795114, the entire contents of each of which are herein incorporated by reference in their entirety for all purposes.

The Al-metal batteries which have been prepared suffer from a variety of disadvantages including instability during use, including instability over the total operation time of the battery. In prior publications, Al-metal batteries were cycled, and, if they remained stable, for example, they only remained stable for up to 100 hours of operation time, e.g., cycled at 70 C rate for 7000 cycles. What is needed, for example is batteries that can be cycled and remain stable at 1 C rate for 7000 cycles, which would include 7000 hours of operation time. The prior-published Al-metal batteries showed capacity and/or coulombic efficiency fade after a few electrochemical charge-discharge cycles. One unresolved problem relates to the lack of chemically compatible materials which can be used to enclose an Al-metal anode rechargeable battery. Such materials need to be chemically compatible with the acidic environment of the chloride-containing electrolytes used with Al-metal anode rechargeable battery and also sufficiently strong to contain the battery components. Another problem relates to the hygroscopic nature of ionic liquid electrolytes. Trace amounts of water in these electrolytes are difficult to remove and can form hydrochloric acid (HCl), hydrogen gas (H₂) and carbon dioxide (CO₂). If these by-products are sealed in the battery, they can result in corrosion, deformation, or destruction of the battery or its packaging.

In view of these as well as other unmet challenges, there exists a need for improved metal anode rechargeable batteries, including Al-metal anode rechargeable batteries.

### SUMMARY

In one embodiment, set forth herein is a battery which includes a metal anode, a cathode, a separator between the metal anode and the cathode, and an ionic liquid electrolyte (ILE) or deep eutectic solvent electrolyte (DES) in direct contact with the metal anode, the cathode, and the separator. Also included is a chemically compatible enclosure in direct contact with the ILE or DES which encapsulates the metal anode, the cathode, the separator, and the ILE or DES. Also included is a sealable port for a liquid or gas, wherein the sealable port for a liquid or gas extends through and forms a seal with the chemically compatible enclosure. In this battery, the ILE or DES includes a mixture of a metal halide salt and an organic compound. Additionally, the chemically compatible enclosure comprises a material selected from the group consisting of a hydrophobic polymer, a fluorinated polymer, an aluminum metal, a fluorinated polymer coated pouch, and a fluorinated polymer coated container.

In a second embodiment, set forth herein is a process of step (1) forming an electrolyte in a battery, comprising the following steps providing a battery comprising: a metal anode, a cathode, a separator between the metal anode and the cathode, an ionic liquid electrolyte (ILE) or deep eutectic solvent electrolyte (DES) comprising a metal halide salt and an organic compound in direct contact with the metal anode, the cathode, and the separator, a chemically compatible enclosure in direct contact with the ILE or DES and encapsulating the metal anode, the cathode, and the separator, and a sealable port for a liquid or gas sealed to the chemically compatible enclosure; wherein the chemically compatible enclosure comprises a material selected from the group consisting of a hydrophobic polymer, a fluorinated polymer, an aluminum metal, a fluorinated polymer coated pouch, and a fluorinated polymer coated container; and step (2) reducing the pressure inside the battery by drawing a vacuum while cycling the battery at least two or more times.

In a third embodiment, set forth herein is a process of making an ionic liquid electrolyte (ILE), comprising the following steps: step (1) providing an ILE in a sealed a chemically compatible enclosure comprises a material selected from the group consisting of a hydrophobic polymer, a fluorinated polymer, an aluminum metal, a fluorinated polymer coated pouch, and a fluorinated polymer coated container, wherein the ILE comprises a mixture of a metal halide and an organic compound; and step (2) reducing the pressure in or around the sealed electrochemical cell by drawing a vacuum while cycling the electrochemical cell at least two or more times.

In a forth embodiment, set forth herein is a process for making an ionic liquid or deep eutectic solvent electrolyte for rechargeable metal ion battery, the process comprising providing an ionic liquid electrolyte in an electrochemical cell that is in a sealed chemically compatible enclosure comprises a material selected from the group consisting of a hydrophobic polymer, a fluorinated polymer, an aluminum metal, a fluorinated polymer coated pouch, and a fluorinated polymer coated container, wherein the ILE comprises a mixture of a metal halide and an organic compound; and wherein the sealed chemically compatible enclosure is sealed under vacuum; and reducing the pressure in or around the electrochemical cell by drawing a vacuum on or around the ionic liquid electrolyte while cycling the electrochemical cell at least two or more times.

In a fifth embodiment, set forth herein is an electrolyte made by a process set forth herein.

### BRIEF DESCRIPTIONS OF THE DRAWINGS

FIG. 1 shows certain components of an Al-ion battery described herein.

FIG. 2 shows certain components of an Al-ion battery enclosed in a fluorinated ethylene propylene (FEP) pouch described herein.

FIG. 3 shows a cross-section of an embodiment of an Al-ion battery described herein having a FEP pouch in an Al-laminated/polypropylene pouch and having seal for a liquid or a gas made of a polyethylene (PE) and polypropylene (PP).

FIG. 4 shows an outside-view of an embodiment of an Al-ion battery described herein having a FEP pouch in an Al-laminated/polypropylene pouch and having seal for a liquid or a gas made of a polyethylene (PE) and polypropylene (PP).

FIG. 5 shows the charge/discharge cycling results from the battery described in Example 1—a vacuum-sealed Al-ion battery with a conventional aluminum laminated pouch—as a plot of specific capacity (left y-axis; mAh/g) as a function of cycle number (x-axis) overlaid with a plot of coulombic efficiency (right y-axis, CE) as a function of cycle number (x-axis). In the figure, the numbers “2.4/100” and “2.4/100” refer to the cut-off voltage (2.4) and current density (either 100 or 200 mA/g), as indicated in each position of the figure.

FIG. 6 shows the charge/discharge cycling results from the battery described in Example 2—a vacuum-sealed Al-ion battery with a FEP chemically compatible enclosure—as a plot of specific capacity (left y-axis; mAh/g) as a function of cycle number (x-axis) overlaid with a plot of coulombic efficiency (right y-axis, CE) as a function of cycle number (x-axis).

FIG. 7 shows the charge/discharge cycling with continuous pumping results from Example 3 for a vacuum-sealed Al-ion battery enclosed in a FEP chemically compatible enclosure as a plot of specific capacity (left y-axis; mAh/g) as a function of cycle number (x-axis) overlaid with a plot of coulombic efficiency (right y-axis, CE) as a function of cycle number (x-axis).

FIG. 8 shows cycling performance of an Al battery in Example 4 having an impure W foil as a cathode substrate.

FIG. 9 shows cycling performance of an Al battery in Example 4 having a highly pure W mesh as a cathode substrate.

FIG. 10 shows charge/discharge cycling results of a first Al-ion battery described in Example 5 which was enclosed in a chemically compatible FEP pouch and which, after assembly, was subjected to continuous vacuum-pumping for sixteen (16) charge/discharge cycles and then sealed. The battery included an electrolyte having an AlCl₃/1-ethyl-3-methylimidazolium chloride (EMIC) mole ratio of 1.5. EMIC=1-ethyl-3-methylimidazolium chloride.

FIG. 11 shows charge/discharge cycling results of a second Al-ion battery described in Example 5 which was enclosed in a chemically compatible FEP pouch and which, after assembly, was subjected to continuous vacuum-pumping for forty-five (45) cycles and then sealed. The battery included an electrolyte having an AlCl₃/EMIC mole ratio of 1.7. The plot is of specific capacity (left y-axis; mAh/g) as a function of cycle number (x-axis) overlaid with a plot of coulombic efficiency (right y-axis, CE) as a function of cycle number (x-axis).

FIG. 12 shows charge/discharge cycling results of a third Al-ion battery described in Example 5 which was enclosed in a chemically compatible FEP pouch and which, after assembly, was subjected to continuous vacuum-pumping for fifteen (15) cycles and then sealed. The battery included an electrolyte having an AlCl₃/EMIC mole ratio of 1.3. The plot is of specific capacity (left y-axis; mAh/g) as a function of cycle number (x-axis) overlaid with a plot of coulombic efficiency (right y-axis, CE) as a function of cycle number (x-axis).

FIG. 13 shows an optical image of a 1 ampere-hour (Ah) Al-ion batteries enclosed in chemically compatible FEP pouches.

FIG. 14 shows charge/discharge cycling results of a 1 Ah Al-ion battery enclosed in a chemically compatible FEP pouch and which was made with continuous vacuum-pumping for twenty-five (25) cycles and then sealed. The AlCl₃/EMIC with mole ratio of 1.5 was used. The plot is of specific capacity (left y-axis; mAh/g) as a function of cycle number (x-axis) overlaid with a plot of coulombic efficiency (right y-axis, CE) as a function of cycle number (x-axis).

FIG. 15 shows charge/discharge cycling results for a 1Ah Al-ion battery enclosed in a chemically compatible FEP pouch and which was made with continuous vacuum-pumping for 25 cycles and then sealed. The AlCl₃/EMIC with mole ratio of 1.5 was used. The plot is of E_{cell} voltage (left y-axis; V) as a function of cycle number (x-axis) overlaid with a plot of coulombic efficiency (right y-axis, CE) as a function of cycle number (x-axis).

FIG. 16 shows a schematic illustration of electrochemical reactions which may occur in an Al-ion battery described herein.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the inventions herein are not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### General

Set forth herein are materials and methods for making and using long-cycle life batteries having ionic liquid (IL) and ionic liquid analogue (ILA) electrolytes. In some examples, the batteries herein include chemically resistant pouches or containers made of fluorinated materials, such as fluorinated ethylene propylene (FEP) and polytetrafluoroethylene (PTFE). These fluorinated materials are useful for preventing corrosion of the pouch or container by the IL or ILA electrolyte filled inside. Also set forth herein are methods and devices for removing trace amounts of water and electrochemical cycling by-products from a battery. In some examples, set forth herein is a vacuum tube mounted onto a pouch or container which includes a material chemically compatible with the battery components. After sealing and/or placing the battery inside such a pouch or container, set forth herein are methods of vacuum-pumping the battery through the vacuum tube which charging and discharging it for the first 30-60 cycles or more. These methods remove residual water, side-reaction products and sources of hydrogen that could reacts with an electrolyte to form hydrochloric acid and hydrogen gas during use. After vacuum-pumping while cycling for the first 30-60 cycles, set forth herein are methods of sealing the battery pouch or container to provide a highly stable Al-metal anode batteries with a long cycle life. In some examples, this includes sealing the vacuum tube or the port in the pouch or container through which the vacuum tube is positioned. In many examples herein, the cycle life stability, when considered for the operation time of the battery, is greater than 2000 cycles at 1 C rate and tens of thousands cycles at faster rate. Also set forth herein are high purity (e.g., greater than 99.9% pure) metal substrates suitable as current collectors. These substrates include Nickel (Ni) foil and Tungsten (W) foil, as well as high purity metal meshes, such as Ni mesh and W mesh.

In some methods herein, the batteries are subjected to vacuum-pumping during charge-discharge cycles for the first 30-60 cycles to remove any volatile side reaction products including any source of hydrogen containing species which could react with the electrolyte to form HCl or H₂ gas. In these methods, the cycling is typically accomplished with 2.4 V charge cut-off voltage at room temperature or with 2.6 V charge cut-off voltage when conducted at −20° C. In some of these methods, the cycling is accomplished with both a 2.4 V and a 2.6 V charge cut-off voltage. After this vacuum-pumping, some of these batteries are sealed under vacuum and do not require additional vacuum-pumping. In some examples, the batteries herein have a cycle life of thousands of cycles when cycled at about 1 C-rate and tens of thousands of cycles when cycled at 5 to 60 C-rate. In some of these examples, the metal current collectors used with the graphite-including cathode included Nickel (Ni) foil and Tungsten (W) foil, Ni mesh and W mesh. The metals are in some examples more than 99.9% pure.

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “about,” when qualifying a number, e.g., 100° C., refers to the number qualified and optionally the numbers included in a range about that qualified number that includes ±10% of the number. For example, about 100° C. includes 100° C. as well as 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., and 110° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including an anode and a cathode, which have ionic communication between the two using an electrolyte.

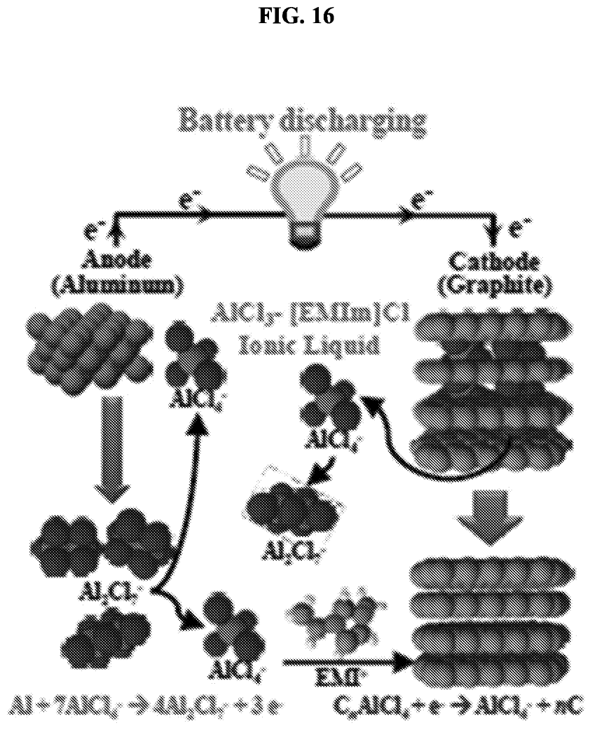

As used herein, the terms “cathode” and “anode” refer to the electrodes of a battery. As shown in FIG. 16, the anode of an Al-metal anode battery includes Al. As shown in FIG. 16, the cathode includes graphite. During charging, AlCl₄⁻ ions de-intercalate from the graphite and conduct through the electrolyte to eventually plate out Al at the anode. During discharging, Al₂Cl₇⁻ ions dissolve from the Al anode, convert into AlCl₄⁻ ions while conducting through the electrolyte and eventually intercalate in the graphite in the cathode. During a charge cycle, electrons leave the cathode and move through an external circuit to the anode. During a discharge cycle, electrons leave the anode and move through an external circuit to the cathode. Unless otherwise specified, the cathode refers to the positive electrode. Unless otherwise specified, the anode refers to the negative electrode.

As used here, the phrase “direct contact,” refers to the juxtaposition of two materials such that the two materials contact each other sufficiently to conduct either an ion or electron current. As used herein, direct contact refers to two materials in contact with each other and which do not have any materials positioned therebetween.

As used herein, the term “separator,” refers to the physical barrier which electrically insulates the anode and the cathode from each other. The separator is often porous so it can be filled or infiltrated with an electrolyte. The separator is often mechanically robust so it can withstand the pressure applied to the electrochemical cell. Example separators include, but are not limited to, SiO₂ glass fiber separators or SiO₂ glass fiber mixed with a polymer fiber or mixed with a binder.

As used herein, the term “ionic liquid electrolyte” or “ILE,” refers to nonflammable electrolytes which include a mixture of a strong Lewis acid metal halide and Lewis base ligand. Examples include, but are not limited to, AlCl₃ and 1-ethyl-3-methylimidazolium chloride ([EMIm]Cl). Example Lewis base ligands include, but are not limited to, urea, acetamide, or 4-propylpyridine. In a typical ILE having AlCl₃ as a metal halide, AlCl₃ undergoes asymmetric cleavage to form a tetrachloroaluminate anion (AlCl₄⁻) and an aluminum chloride cation (AlCl₂⁺) in which a ligand is datively bonded to (or associated through coordination via sharing of lone pair electrons) the AlCl₂⁺ cation, forming ([AlCl₂·n(ligand)]⁺). Ionic liquids are useful as electrolytes for Al-metal anode batteries. Examples include AlCl₃ and 1-ethyl-3-methylimidazolium chloride (EMIC), AlCl₃ and urea, AlCl₃ and acetamide, AlCl₃ and 4-propylpyridine, and AlCl₃ and trimethylphenylammonium chloride.

As used herein, the term “deep eutectic solvent,” “deep eutectic solvent electrolyte,” or “DES,” refers to a mixture of a strong Lewis acid metal halide and a Lewis base ligand. See, for example, Hogg, J M, et al., Green Chem 17(3):1831-1841; Fang, Y, et al., Electrochim Act 160:82-88; Fang, Y, et al., Chem. Commun. 51(68)13286-13289; and also Pulletikurthi, G., et al., Nature, 520(7547):325-328 for a non-limiting set of example DES mixture. The content of each of these references in herein incorporated by reference in its entirety for all purposes. Examples include, but are not limited to, AlCl₃ and urea.

As used herein, the term “chemically compatible enclosure,” refers to an enclosure which physically contains an anode, cathode, separator and electrolyte without resulting in a substantial amount of corrosion. A substantial amount of corrosion includes an amount which degrades the coulombic efficiency of a battery by more than 10% or which reduces its capacity by more than 10%. Chemical compatibility is considered with respect to the reactivity of a material and an ILE or DES. A material which reacts with an ILE or DES, e.g., polypropylene, and degrades the coulombic efficiency of a battery by more than 10% or which reduces its capacity by more than 10%, is not chemically compatible, as the phrase is used herein. Chemically compatible enclosures herein do not include Swage-log battery cells, plastic pouches or sealed glass battery cells. A non-limiting example of a chemically compatible enclosure is a FEP pouch surrounding a cathode, anode and ILE or DES. Surrounding the FEP pouch is a second multilayered pouch in which the multilayered pouch walls comprise sequential layers of a polyamide polymer layer/an adhesive layer/an aluminum layer/adhesive layer/and a polypropylene polymer layer. In some examples, the polyamide polymer layer is the outer-most layer of the pouch. In some examples, the inner layer, which contacts the FEP pouch, is the polypropylene layer. When viewed from the outside the polyamide layer is visible, in some examples. In some examples, under the polyamide layer is an adhesive. In some examples, under the adhesive is an aluminum layer. In some examples, under the aluminum layer is another adhesive. In some examples, under the another adhesive is the polypropylene layer. In some examples, under the polypropylene layer is the FEP pouch. And inside the FEP pouch, in some examples, is the cathode, anode, and ILE (or DES).

As used herein, the term “sealable port for a liquid or gas,” refers to a port, a tube, a hole, a conduit, a channel, a seam, or the like which can be included with an enclosure to provide for the transfer of liquids or gases into or out of the enclosure. The sealable port for a liquid or gas extends through or traverses the enclosure but forms a seal with the enclosure at the points through which it extends through or traverses the enclosure. The sealable port for a liquid or gas is capable of being sealed after it has been used for the transfer of liquids or gases into or out of the enclosure. For example, a tube can extend through an enclosure which encloses a battery. The tube, once sealed, in combination with the enclosure seals the battery and protects it from exposure to ambient conditions. Before the tube is sealed, the tube can be used to vacuum-pump gases out of the battery. Once the gases are vacuum-pumped out of the battery, the tube can be sealed, either reversibly or permanently.

As used herein, the term “metal halide salt,” refers to a salt which includes at least one metal atom and at least one halogen atom. Examples include, but are not limited to, AlF₃, AlCl₃, AlBr₃, AlI₃, and combinations thereof.

As used herein, the term “particle size,” refers to the average dimension characteristic of the longest length, side, or diameter of the particle. For particles which are spherical or approximately spherical, particle size refers to the average diameter of the particles. As used herein, particle size is measured by scanning electron microscopy (SEM), unless specified otherwise to the contrary. In some specific examples, particle size may be selected by sieving through a well-defined mesh.

As used herein, the term “graphitized,” refers to a material which includes graphite.

As used herein, the term “crystalline,” refers to a material which diffracts x-rays. Crystalline graphite is characterized by at least an XRD peak at 26.55 2Θ (the (002) peak of graphite having a d-spacing of 3.35 Å). Graphite is mined as either vein, flake, or microcrystalline. Herein, graphite can be vein, flake microcrystalline, or a combination thereof. In some examples, the graphite is flake graphite. In some examples, the graphite is natural flake graphite.

As used herein, the term “few defects,” refers to graphite that has less than 5% defects per mole. Defects include, but are not limited to, misshaped particles, amorphous carbon, or particles having a particle size other than the average particle size. Defects in graphite can be measured using Raman spectroscopy and comparing the defect D band intensity relative to the graphite G band. In some examples, the ratio D/G is about near zero for natural graphite with few defects. In some examples, the ratio D/G is about zero for natural graphite with few defects.

As used herein, “pouch,” is used interchangeably with the phrase “prismatic cell.”

As used herein, the term “cycling,” refers to an electrochemical process whereby an electrochemical cell having an anode and a cathode is charged and discharged.

As used herein, the phrase “wherein the ILE or DES does not wet the chemically compatible enclosure,” refers to the interaction between an ILE or DES and the interior surface of the chemically compatible enclosure.” Wetting is determined by a contact angle measurement. In this contact angle measurement, an ILE or DES is deposited onto an interior surface of the chemically compatible enclosure. The ILE or DES wets this interior surface of the chemically compatible enclosure when the contact angle between the interior surface of the chemically compatible enclosure and a line tangent to the surface of the ILE or DES, which is deposited thereupon, is less than or equal to 90°. The ILE or DES does not wets the interior surface of the chemically compatible enclosure when the contact angle between the interior surface of the chemically compatible enclosure and a line tangent to the surface of the ILE or DES is greater than 90°. Hydrophilic surfaces are observed to have low contact angles (less than or equal to 90 degrees) with respect to a solution on the hydrophilic surface. Hydrophobic surfaces are observed to have high contact angles (greater than 90 degrees) with respect to a solution on the hydrophobic surface.

As used herein, the term “C-rate” refers to a measure of the rate at which a battery is discharged relative to its maximum capacity. A 1 C rate means that the discharge current will discharge the entire battery in 1 hour. For a battery with a capacity of 100 Amp-hrs, a 1 C rate equates to a discharge current of 100 Amps.

### Chemistry

As illustrated in an embodiment in FIG. 16, an electrochemical cell includes, in some examples, an Al anode and a graphite-including cathode. During a discharging reaction, Al reacts at the anode interface to form Al₂Cl₇⁻ ions which are solvated by an ionic liquid and react to form AlCl₄⁻. During a discharge, electrons conduct by way of an external circuit from the anode to the cathode. Also, during discharging, AlCl₄⁻ intercalates into graphite as carbon is oxidized. In this example, the ionic liquid is illustrated as AlCl₃-1-ethyl-3-methylimidazolium chloride ([EMIM]Cl). During charging, the Al₂Cl₇⁻ is reduced to deposit Al metal at the anode interface. During a charge, electrons conduct by way of an external circuit from cathode to the anode. In some of the examples, herein, the mole ratio of AlCl₃:[EMIm]Cl is about 1.3:1, 1.4:1, 1.5:1, 1.6:1, 1.7:1, 1.8:1, or 1.9:1 unless specified otherwise

Ionic liquid electrolytes can be formed by slowly mixing or otherwise combining an aluminum halide (e.g., AlCl₃) and an organic compound. In certain examples, the aluminum halide undergoes asymmetric cleavage to form a haloaluminate anion (e.g., AlCl₄⁻) and an aluminum halide cation that is datively bonded to the organic compound serving as a ligand (e.g., [AlCl₂·n(ligand)]⁺). A mole ratio of the aluminum halide and the organic compound can be at least or greater than about 1.1 or at least or greater than about 1.2, and is up to about 1.5, up to about 1.8, up to about 2, or more. For example, the mole ratio the aluminum halide and the organic compound (e.g., urea) can be in a range of about 1.1 to about 1.7 or about 1.3 to about 1.5. In some embodiments, a ligand is provided as a salt or other compound including the ligand, and a mole ratio of the aluminum halide and the ligand-containing compound can be at least or greater than about 1.1 or at least or greater than about 1.2, and is up to about 1.5, up to about 1.8, up to about 2, or more. An ionic liquid electrolyte can be doped, or have additives added, to increase its electrical conductivity and lower the viscosity, or can be otherwise altered to yield compositions that favor the reversible electrodeposition of metals. For example, 1,2-dichlorobenzene can be added as a co-solvent to reduce electrolyte viscosity and increase the voltage efficiency, which can result in an even higher energy density. Also, alkali chloride additives can be added to increase the discharge voltage of a battery. In some examples, 1-ethyl-3-methylimidazolium tetrafluoroborate or 1-ethyl-3-methylimidazolium bis(trifluoromethane sulfonimide) or 1-ethyl-3-methylimidazolium hexafluorophosphate can be added as additives to increase the discharge voltage of a battery.

Other ionic liquid electrolytes are suitable for use with an Al-metal anode battery. For example, AlCl₃:Urea can be used as an ionic liquid electrolyte. In certain examples, Aluminum deposition proceeds through two pathways, one involving Al₂Cl₇⁻ anions and the other involving [AlCl₂·(urea)n]+ cations. The following simplified half-cell redox reactions describe this process:

2[AlCl₂·n(urea)]⁺+3e⁻→Al+AlCl₄⁻+2n(urea)

Cₙ(AlCl₄⁻)+e⁻→Cₙ+AlCl₄⁻

which gives an overall battery reaction (including counter ions):

2([AlCl₂·n(urea)]+AlCl₄⁻)+3C_{n→Al+}3CₙAlCl₄+2n(urea).

### Batteries

In some examples, set forth herein is a battery which includes a metal anode, a cathode, a separator between the metal anode and the cathode, an ionic liquid electrolyte (ILE) or deep eutectic solvent electrolyte (DES) in direct contact with the metal anode, the cathode, and the separator, a sealable port for a liquid or gas, and a chemically compatible enclosure in direct contact with the ILE or DES and encapsulating the metal anode, the cathode, the separator, and the ILE or DES, and a seal between the sealable port for a liquid or gas and the chemically compatible enclosure. In this battery, the ILE or DES includes a metal halide salt and an organic compound. In some examples, the ILE or DES includes a mixture of a metal halide salt and an organic compound, and the sealable port for a liquid or gas extends through the chemically compatible enclosure. Also in this battery, in some examples, the sealable port for a liquid or gas and the chemically compatible enclosure form a seal therebetween which is the seal between the sealable port for a liquid or gas and the chemically compatible enclosure.

In some examples, set forth herein is a battery which includes a metal anode, a cathode, a separator between the metal anode and the cathode, and an ionic liquid electrolyte (ILE) or deep eutectic solvent electrolyte (DES). The ILE or DES includes a metal halide salt and an organic compound. The ILE or DES are in direct contact with the metal anode, the cathode, and the separator. Enclosing the battery is a chemically compatible enclosure. The chemically compatible enclosure is in direct contact with the ILE or DES and encapsulates the metal anode, the cathode, and the separator. The chemically compatible enclosure also includes a sealable port for a liquid or gas which is sealed to the chemically compatible enclosure. When batteries such as those described herein are cycled and subjected to vacuum-pumping, the liquids and gases which may be vacuum-pumped out of the battery are vacuum-pumped through the sealable port for a liquid or gas which is sealed to the chemically compatible enclosure.

In some examples, the chemically compatible enclosure includes a material selected from a fluorinated polymer, aluminum metal, and combinations thereof. In some examples, the chemically compatible enclosure includes a fluorinated polymer. In some other examples, the chemically compatible enclosure includes aluminum metal. In certain other examples, the chemically compatible enclosure includes, in addition to a fluorinated polymer, a polyethylene polymer which is not in direct contact with the ionic liquid electrolyte. In some examples, the chemically compatible enclosure includes, in addition to a fluorinated polymer, a polypropylene polymer which is not in direct contact with the ionic liquid electrolyte. In some examples, the chemically compatible enclosure includes combinations of a fluorinated polymer, aluminum metal, polyethylene, and polypropylene, but wherein the polyethylene and polypropylene polymers, when present, are not in direct contact with the ionic liquid electrolyte. In some examples, including any of the foregoing, the fluorinated polymer layer is in contact with the ionic liquid electrolyte. In some examples, including any of the foregoing, the aluminum metal is between the fluorinated polymer layer and another polymer layer, such as a polypropylene layer.

In some examples, the chemically compatible enclosure includes a fluorinated polymer.

In some examples, the chemically compatible enclosure includes a pouch.

In some examples, the chemically compatible enclosure is a pouch.

In some examples, the chemically compatible enclosure includes a container. In some examples, the chemically compatible enclosure is a container. In certain examples, the container is a hard or rigid container. In some of these examples, the container is a can, such as but not limited to an 18650 can. In some examples, the can is an Al can.

In some examples, including any of the foregoing, the pouch is coated with a fluorinated polymer. In some examples, including any of the foregoing, the container is coated with a fluorinated polymer.

In some examples, including any of the foregoing, the fluorinated polymer protects the metal anode, the cathode, and the ionic liquid electrolyte from exposure to ambient conditions. In some examples, including any of the foregoing, the fluorinated polymer is free of corrosion from the ILE or DES. In some examples, including any of the foregoing, the fluorinated polymer does not react with the ILE or DES. In some examples, including any of the foregoing, the fluorinated polymer has a thickness of about 1-1000 μm.

In some examples, the total width of the chemically compatible enclosure is about 50 μm to about 200 μm. In some examples, the total width of the chemically compatible enclosure is about 50 μm. In some examples, the total width of the chemically compatible enclosure is about 60 μm. In some examples, the total width of the chemically compatible enclosure is about 70 μm. In some examples, the total width of the chemically compatible enclosure is about 80 μm. In some examples, the total width of the chemically compatible enclosure is about 90 μm. In some examples, the total width of the chemically compatible enclosure is about 100 μm. In some examples, the total width of the chemically compatible enclosure is about 110 μm. In some examples, the total width of the chemically compatible enclosure is about 120 μm. In some examples, the total width of the chemically compatible enclosure is about 130 μm. In some examples, the total width of the chemically compatible enclosure is about 140 μm. In some examples, the total width of the chemically compatible enclosure is about 150 μm. In some examples, the total width of the chemically compatible enclosure is about 160 μm. In some examples, the total width of the chemically compatible enclosure is about 170 μm. In some examples, the total width of the chemically compatible enclosure is about 180 μm. In some examples, the total width of the chemically compatible enclosure is about 190 μm. In some examples, the total width of the chemically compatible enclosure is about 200 μm. In some of these examples, the thickness of the fluorinated polymer layer is 70-150 μm. In some of these examples, the thickness of the aluminum layer is 70-150 μm.

In some examples, including any of the foregoing, the fluorinated polymer has a thickness of about 50 μm-250 μm. In certain examples, the fluorinated polymer has a thickness of about 50 μm. In certain examples, the fluorinated polymer has a thickness of about 60 μm. In certain examples, the fluorinated polymer has a thickness of about 70 μm. In certain examples, the fluorinated polymer has a thickness of about 80 μm. In certain examples, the fluorinated polymer has a thickness of about 90 μm. In certain examples, the fluorinated polymer has a thickness of about 100 μm. In certain examples, the fluorinated polymer has a thickness of about 110 μm. In certain examples, the fluorinated polymer has a thickness of about 120 μm. In certain examples, the fluorinated polymer has a thickness of about 130 μm. In certain examples, the fluorinated polymer has a thickness of about 140 μm. In certain examples, the fluorinated polymer has a thickness of about 150 μm. In certain examples, the fluorinated polymer has a thickness of about 160 μm. In certain examples, the fluorinated polymer has a thickness of about 170 μm. In certain examples, the fluorinated polymer has a thickness of about 180 μm. In certain examples, the fluorinated polymer has a thickness of about 190 μm. In certain examples, the fluorinated polymer has a thickness of about 50 μm. In certain examples, the fluorinated polymer has a thickness of about 200 μm. In certain examples, the fluorinated polymer has a thickness of about 210 μm. In certain examples, the fluorinated polymer has a thickness of about 220 μm. In certain examples, the fluorinated polymer has a thickness of about 230 μm. In certain examples, the fluorinated polymer has a thickness of about 240 μm. In certain examples, the fluorinated polymer has a thickness of about 250 μm.

In some examples, including any of the foregoing, the fluorinated polymer is a single layer. In some examples, including any of the foregoing, the fluorinated polymer is a multi-layer. In some examples, including any of the foregoing, the fluorinated polymer is a bi-layer. In some examples, including any of the foregoing, the fluorinated polymer is a tri-layer. In some examples, including any of the foregoing, the fluorinated polymer is a combination of four layers of the fluorinated polymer. In some examples, including any of the foregoing, the fluorinated polymer is a combination of five layers of the fluorinated polymer. In some examples, including any of the foregoing, the fluorinated polymer is a combination of four layers of the fluorinated polymer. In some examples, including any of the foregoing, the fluorinated polymer is a combination of six layers of the fluorinated polymer. In some examples, including any of the foregoing, the fluorinated polymer is a combination of seven layers of the fluorinated polymer. In some examples, including any of the foregoing, the fluorinated polymer is a combination of eight layers of the fluorinated polymer. In some examples, including any of the foregoing, the fluorinated polymer is a combination of nine layers of the fluorinated polymer. In some examples, including any of the foregoing, the fluorinated polymer is a combination of ten layers of the fluorinated polymer. In some examples, including any of the foregoing, the fluorinated polymer is a combination of more than ten layers of the fluorinated polymer. In some examples, including any of the foregoing, the fluorinated polymer is a multilayer. In some examples, including any of the foregoing, each layer has thickness of 50 μm-250 μm, including all thickness values within this range.

In some examples, including any of the foregoing, the fluorinated polymer is selected from fluorinated ethylene propylene (FEP), polytetrafluoroethylene (PTFE), polyvinylidene fluoride (PVDF), hexafluoropropylene (HFP), and combinations thereof. In some examples, the fluorinated polymer is FEP. In some examples, the fluorinated polymer is PTFE. In some examples, the fluorinated polymer is PVDF. In some examples, the fluorinated polymer is HFP. In some examples, the fluorinated polymer is PVDF-HFP.

In some examples, including any of the foregoing, the fluorinated polymer is substituted with a hydrophobic polymer selected from polytetrafluoroethylene (PTFE), polyacrylonitrile (PAN), fluorinated ethylene propylene (FEP), polychlorotrifluoroethylene (PCTFE), polyvinylidene fluoride (PVDF), hexafluoropropylene (HFP), PVDF-HFP, and polyfluoroalkoxy (PFA). A hydrophobic polymer, as used herein, is a polymer which ILE or DES does not wet.

In some examples, including any of the foregoing, the chemically compatible enclosure includes Al metal. In some examples, the Al metal is free of corrosion from the ILE or DES. In some examples, the Al metal container does not react with the ILE or DES. In some examples, the chemically compatible container is a pouch containing the metal anode, the cathode, the separator, and the ILE or DES. In some of these examples, the pouch is surrounded by a rigid housing. In some other of these examples, the rigid housing is a module. In some of these examples, the rigid housing is selected from a coin cell and can cell. In some examples, the rigid housing is a coin cell. In some examples, the rigid housing is a can cell.

In some examples, including any of the foregoing, the pouch is surrounded by an Al layer.

In some examples, including any of the foregoing, the pouch is surrounded by a non-fluorinated polymer. In some of these examples, the pouch is surrounded by a non-fluorinated polymer which is between an Al layer and the pouch. In some of these examples, the non-fluorinated polymer is polypropylene (PP). In these examples, the PP polymer is not in direct contact with the ionic liquid electrolyte.

In some examples, including any of the foregoing, the sealable port for a liquid or gas includes a FEP tube, a PP tube, a polyethylene tube, a metal tube or a combination thereof. In certain examples, the sealable port for a liquid or gas includes a FEP tube. In certain examples, the sealable port for a liquid or gas includes a PP tube. In certain examples, the sealable port for a liquid or gas includes a polyethylene (PE) tube. In certain examples, the sealable port for a liquid or gas includes a metal tub. In certain examples, the sealable port for a liquid or gas includes a combination of a FEP tube, a PP tube, a polyethylene tube, and a metal tube. In some examples, the sealable port for a liquid or gas includes a metal tube. In some examples, the metal tube is an Al metal tube. In some examples, the sealable port for a liquid or gas includes a FEP tube. In some examples, the sealable port for a liquid or gas includes a PP tube. In some examples, including any of the foregoing, the sealable port for a liquid or gas is about 1-2 mm in diameter.

In some examples, the sealable port for a liquid or gas includes an outer polyethylene tube extending away from the chemically compatible enclosure which is connected to a polypropylene tube extending through the chemically compatible enclosure. In this example, the polyethylene and polypropylene tubes are bonded or fused together such that the two tubes form a single tube.

In some examples, the PP tube is sealed to a polypropylene layer which is between an Al layer and the chemically compatible enclosure.

In some examples, including any of the foregoing, the sealable port for a liquid or gas includes a FEP tube and the chemically compatible enclosure is a fluorinated polymer selected from FEP.

In some examples, including any of the foregoing, the metal anode is a metal selected from the group consisting of lithium (Li), sodium (Na), potassium (K), magnesium (Mg), calcium (Ca), aluminum (Al), germanium (Ge), tin (Sn), silicon (Si), zinc (Zn), nickel (Ni), cobalt (Co), iron (Fe), combinations thereof, and alloys thereof. In some examples, including any of the foregoing, the metal anode is a Li metal anode. In some examples, including any of the foregoing, the metal anode is a Na metal anode. In some examples, including any of the foregoing, the metal anode is a K metal anode. In some examples, including any of the foregoing, the metal anode is a Mg metal anode. In some examples, including any of the foregoing, the metal anode is a Ca metal anode. In some examples, including any of the foregoing, the metal anode is a Al metal anode. In some examples, including any of the foregoing, the metal anode is a Ge metal anode. In some examples, including any of the foregoing, the metal anode is a Sn metal anode. In some examples, including any of the foregoing, the metal anode is a Zn metal anode.

In some embodiments, set forth herein is a method of manufacturing a metal-ion battery includes: 1) providing an anode including aluminum; 2) providing a cathode; and 3) providing an ionic liquid electrolyte, wherein providing the ionic liquid electrolyte includes: a) combining an aluminum halide and an organic compound to form an ionic liquid; b) subjecting the ionic liquid to vacuum for about 0.2 h to about 24 h to remove residual water, hydrochloric acid or organic impurities; and c) subjecting the ionic liquid to vacuum under cycling conditions.

### Figures

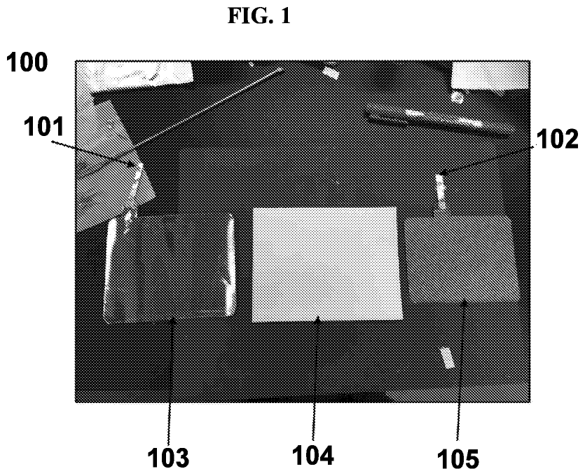

FIG. 1 shows 100: a collection of some of the parts of an embodiment of an Al-ion battery described herein. Included in such a battery is the Al metal anode (103). This anode has an Al tab (101) which is used to connect the battery to an external circuit. Included in this battery is the cathode (105) which includes a Ni foil substrate coated with graphite. The cathode has a Ni tab (102) which is used to connect the battery to an external circuit. Included in this battery is a SiO₂ glassy fiber separator (104).

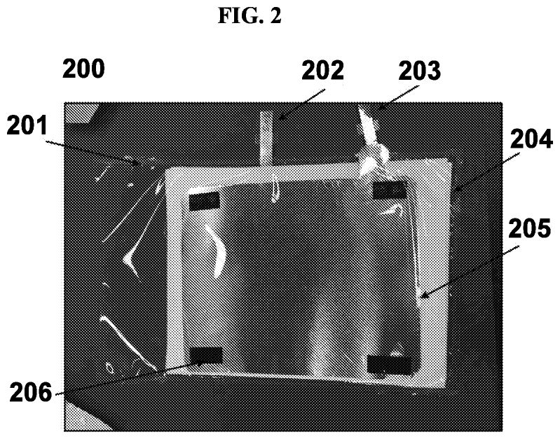

FIG. 2 shows 200: an embodiment of an Al-ion battery described herein inside an FEP pouch. In this assembled battery, the Al metal anode (205) is spaced apart from the cathode, which includes a Ni foil substrate coated with graphite, by a separator (204). The anode has an Al tab (203) and the cathode has a Ni tab (202). This stack of anode-separator-cathode is enclosed in an FEP pouch (201). In this embodiment, carbon conductive adhesive tape (206) is used to adhere the Al metal anode to the FEP pouch. Other adhesive materials are envisioned within the scope of the instant disclosure.

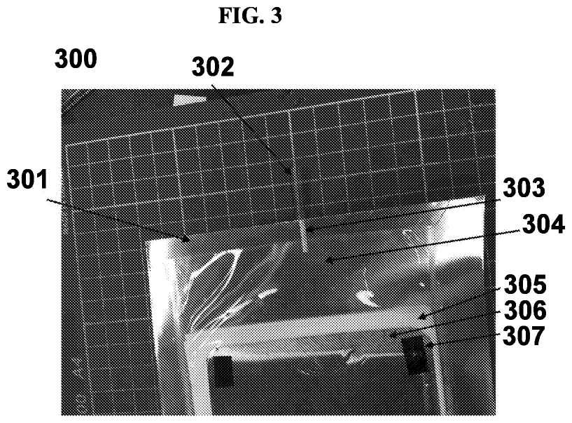

FIG. 3 shows 300: an embodiment of an Al-ion battery described herein inside an FEP pouch surrounded by an Al-laminated foil pouch (301) with a PP inner-layer. In this assembled battery, the Al metal anode (306) is spaced apart from the cathode, which includes a Ni foil substrate coated with graphite, by a separator (305). This stack of anode-separator-cathode is enclosed in an FEP pouch (304). In this embodiment, carbon conductive adhesive tape (307) is used to adhere the Al metal anode to the FEP pouch. Other adhesive materials are envisioned within the scope of the instant disclosure. Also shown in FIG. 3 is a tube which is comprised of two parts fused or bonded together. One part of this tube is a polyethylene (PE) tube (302) and the other part, which is fused or bonded to it, is a polypropylene (PP) tube (303). Together, 302 and 303 form a single tube.

In some examples, the FEP pouch is substituted with a different fluorinated polymer (e.g., PTFE) and or hydrophobic polymers described herein. In some examples, the pouch is substituted for a hard container. In some examples, the Al-laminated foil pouch warps (i.e., bends) the FEP pouch. However, other than for structural support, the Al-laminated foil pouch is not a necessary component of the batteries set forth herein.

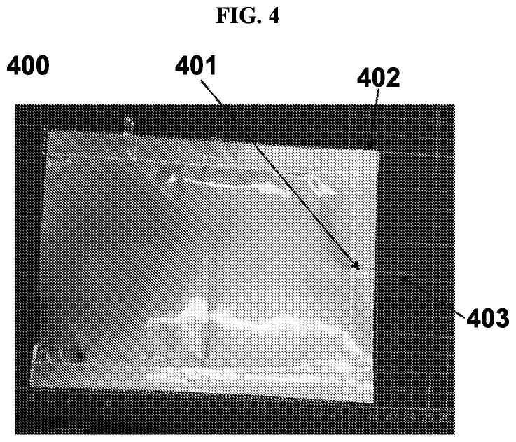

FIG. 4 shows 400: an outside view of an embodiment of an Al-ion battery described herein inside an FEP pouch surrounded by an Al-laminated foil pouch. Extending through this pouch is a single tube comprised of two parts: a PP tube (401) and PE tube (403). The Al-laminated foil pouch is sealed with margins—sealed zones—(402).

In some examples, the PP tube can be sealed with a PP layer of the laminated pouch. In some examples, a FEP tube is used in place of a PP tube. In some of these examples, the FEP tube is sealed with the FEP pouch through which it extends.

In some examples, including any of the foregoing, the cathode in any of the batteries described herein includes carbon selected from natural graphite and synthetic graphite. In some examples, the carbon is natural graphite. In some examples, the carbon is synthetic graphite.

In some examples, including any of the foregoing, the graphite has a particle size of 1 μm to 500 μm. In some of these examples, the graphite has a particle size between about 1 μm and 50 μm, 50 μm and 100 μm, between about 50 μm and 200 μm, or between about 50 μm and 300 μm. In some of these examples, the graphite has a particle size between 20 μm-300 μm. In some of these examples, the graphite has a particle size between 40 μm to 200 μm. In some of these examples, the graphite has a particle size of at least 45 μm.

In some examples, including any of the foregoing, the cathode includes carbon having a particle size from about 45 μm to about 75 μm and carbon having a particle size from about 150 to about 250 μm. In some of these examples, the ratio of these two groups of particle sizes is fixed. In some examples, the gravimetric ratio of the carbon having a particle size from about 45 μm to about 75 μm to carbon having a particle size from about 150 to about 250 μm is 5:95 to 20:80.

In some examples, including any of the foregoing, the graphite is pure natural graphite flake.

In some examples, including any of the foregoing, the graphite is highly crystalline and graphitized.

In some examples, including any of the foregoing, the graphite is substantially free of defects.

In some examples, including any of the foregoing, the cathode includes pyrolytic graphite.

In some examples, including any of the foregoing, the battery further includes a cathode current collector selected from the group consisting of a glassy carbon, carbon fiber paper, carbon fiber cloth, graphite fiber paper, and graphite fiber cloth. In some of these examples, the battery includes a cathode current collector selected from glassy carbon. In some examples, the battery includes a cathode current collector selected from carbon fiber paper. In some examples, the battery includes a cathode current collector selected from carbon fiber cloth. In some examples, the battery includes a cathode current collector selected from graphite fiber paper. In some examples, the battery includes a cathode current collector selected from graphite fiber cloth. In some of these examples, the carbon fiber paper has a thickness between about 10 μm to 300 μm.

In some examples, including any of the foregoing, the battery further includes a cathode current collector selected from the group consisting of a metal substrate. In some examples, the metal substrate is coated with a protective coating. In some examples, the metal substrate is a mesh or a foil. In certain examples, the substrate is mesh. In certain examples, the substrate is foil. In some examples, the metal is nickel (Ni) or tungsten (W). In certain examples, the metal is Ni. In certain examples, the metal is W. In some examples, the protective coating is selected from a Ni coating, a W coating, a carbon coating, a carbonaceous material, a conducting polymer, and a combination thereof. In certain examples, the protective coating is a Ni coating. In certain examples, the protective coating is a W coating. In certain examples, the protective coating is a carbon coating. In certain examples, the protective coating is a carbonaceous material. In certain examples, the protective coating is a conducting polymer.

In some examples, the metal substrate is a Ni foil, a Ni mesh, a W foil, or a W mesh. In some examples, the metal substrate is a metal foil coated with Ni coating. In some examples, the metal substrate is a metal mesh coated with Ni coating. In some examples, the metal substrate is a metal foil coated with W coating. In some examples, the metal substrate is a metal mesh coated with W coating.

In some examples, including any of the foregoing, the metal substrate is Ni and the protective coating is carbon.

In some examples, including any of the foregoing, the cathode includes a polymer binder and a cathode active material blended with the polymer binder.

In some examples, including any of the foregoing, the polymer binder is a hydrophilic polymer binder. In some examples, the polymer binder is a hydrophobic polymer binder. In some of these examples, the hydrophobic polymer binder is selected from polytetrafluoroethylene (PTFE), polyvinylidene fluoride (PVDF), fluorinated ethylene propylene (FEP), hexafluoropropylene (HFP), PVDF-HFP, and combinations thereof.

In some examples, including any of the foregoing, the polymer binder is a hydrophilic polymers selected from polyacrylic acid (PAA) (with or without various degrees of neutralization), polyvinyl alcohol (PVA), PAA-PVA, polyacrylate, polyacrylic, polyacrylic latex, cellulose and cellulose derivatives (e.g., carboxymethyl cellulose (CMC)), alginate, polyethylene oxide, polyethylene oxide block copolymers, polyethylene glycol, styrene-butadiene rubber, poly(styrene-co-butadiene),conducting polymers (e.g., poly(3,4-ethylenedioxythiophene) (PEDOT) and polystyrene sulfonate (PSS)), ionic liquid polymers or oligomers, as well as combinations of two or more of the foregoing hydrophilic polymers, as well as combinations of one or more of the foregoing polymers with one or more hydrophobic polymers, such as styrene-butadiene rubber

In some examples, including any of the foregoing, the cathode includes natural graphite, synthetic graphite, sulfur, selenium, black phosphorous particles, or combinations thereof. In some examples, including any of the foregoing, the separator includes SiO₂ glass fiber. In some examples, including any of the foregoing, the separator is prepared by a process which includes drying the separator under vacuum at about 200° C.

In some examples, including any of the foregoing, the ILE includes urea. In some examples, including any of the foregoing, the DES includes urea.

In some examples, including any of the foregoing, the DES includes a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof.

In some examples, including any of the foregoing, the ILE includes a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof.

In some examples, including any of the foregoing, the ILE or DES includes a mixture of a metal halide and an organic compound. In some examples, including any of the foregoing, the metal halide is an aluminum halide.

In some examples, including any of the foregoing, the aluminum halide is AlCl₃, and the organic compound includes: (a) cations selected from the group consisting of N-(n-butyl) pyridinium, benzyltrimethylammonium, 1,2-dimethyl-3-propylimidazolium, trihexyltetradecylphosphonium, and 1-butyl-1-methyl-pyrrolidinium, and (b) anions selected from the group consisting of tetrafluoroborate, tri-fluoromethanesulfonate, and bis(trifluoromethanesulfonyl)imide.

In some examples, including any of the foregoing, the aluminum halide is AlCl₃, and the organic compound is selected from 4-propylpyridine, acetamide, N-methylacetamide, N,N-dimethylacetamide, trimethylphenylammonium chloride, 1-ethyl-3-methylimidazolium bis(trifluoromethylsulfonyl)imide and 1-ethyl-3-methylimidazolium chloride.

The In some examples, including any of the foregoing, the aluminum halide is AlCl₃, and the organic compound is 1-ethyl-3-methylimidazolium chloride.

In some examples, including any of the foregoing, the ILE includes an aluminum halide cation that is datively bonded to the organic compound.

In some examples, including any of the foregoing, the aluminum halide is AlCl₃, and the organic compound is an amide. In some of these examples, the amide is selected from urea, methylurea, ethylurea, and combinations thereof. In certain examples, the amide is urea. In certain examples, the amide is methylurea. In certain examples, the amide is ethylurea.

In some examples, including any of the foregoing, the metal halide is AlCl₃; and the organic compound is selected from 1-ethyl-3-methyl imidazolium chloride, 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, urea, methylurea, ethylurea, mixtures thereof, and combinations thereof.

In some examples, including any of the foregoing, the ILE includes AlCl₃ and 1-ethyl-3-methyl imidazolium chloride (IL′), the mole ratio of AlCl₃:IL is from 1.1 to 1.7. In some examples the mole ratio is 1.1. In some examples the mole ratio is 1.2. In some examples the mole ratio is 1.3. In some examples the mole ratio is 1.4. In some examples the mole ratio is 1.5. In some examples the mole ratio is 1.6. In some examples the mole ratio is 1.7.

In some examples, including any of the foregoing, the ILE includes a mixture of 1.1 to 1.7 moles AlCl₃, 1.0 mole 1-ethyl-3-methyl imidazolium chloride and 0.1 to 0.5 mole 1-ethyl-3-methylimidazolium bis(trifluoromethylsulfonyl)imide (IL″). In some examples, the mixture includes 1.1, 1.2, 1.3, 1.4, 1.5, 1.6, or 1.7 moles AlCl₃. In some examples, the mixture includes 0.1, 0.2, 0.3, 0.4, or 0.5 moles 1-ethyl-3-methylimidazolium bis(trifluoromethylsulfonyl)imide.

In some examples, including any of the foregoing, the ILE includes AlCl₃ and urea (ILA′). In some examples, including any of the foregoing, the ILE includes AlCl₃ and methylurea (ILA″)

In some examples, including any of the foregoing, the mole ratio of AlCl₃ to ILA′ in the ILE is between 1.1 to 1.7.

In some examples, including any of the foregoing, the mole ratio of AlCl₃ to ILA″ is between 1.1 to 1.7.

In some examples, including any of the foregoing, the ILE is ILA′ and the mole ratio of AlCl₃:urea about 1.1 to about 1.7.

In some examples, including any of the foregoing, the ILE is ILA′ and the mole ratio of AlCl₃:methylurea is about 1.1 to about 1.7.

In some examples, including any of the foregoing, the ILE is ILA′ and the mole ratio of AlCl₃:ethylurea is about 1.1 to about 1.7.

In some examples, including any of the foregoing, wherein the amount of water or hydrochloric acid in the ionic liquid electrolyte is between 0-1000 ppm. In some examples, including any of the foregoing, the amount of water or hydrochloric acid in the ionic liquid electrolyte is less than 1000 ppm. In some examples, including any of the foregoing, the concentration of corrosion products content in the ionic liquid electrolyte is less than 1000 ppm

In some examples, including any of the foregoing, the coulombic efficiency does not decay by more than 5 percent over the first 500-10,000 cycles when the battery is cycled under normal operating conditions. In some examples, including any of the foregoing, the specific capacity does not decay by more than 5 percent over the first 500-10,000 cycles when the battery is cycled under normal operating conditions.

In some examples, including any of the foregoing, set forth herein is a battery including: an Al metal anode, Al current collector having an Al tab, a SiO₂ glass fiber separator, a cathode including graphite on Ni foil, and a Ni, W, or C current collector having a Ni, W, or C tab. In some of these examples, at least one current collector is a mesh. In some of these examples, at least one current collector is a foam.

In some of these examples, including any of the foregoing, the battery is flexible.

In some examples, including any of the foregoing, set forth herein is a battery including: a metal anode, a cathode, a separator between the metal anode and the cathode, an ionic liquid electrolyte (ILE) or deep eutectic solvent electrolyte (DES) including a metal halide salt and an organic compound in direct contact with the metal anode, the cathode, and the separator, a chemically compatible enclosure in direct contact with the ILE or DES and encapsulating the metal anode, the cathode, the separator, and the ILE or DES, and a sealable port for a liquid or gas extending through, and sealed to, the chemically compatible enclosure.

In some examples, including any of the foregoing, the pouch is a prismatic pouch.

### Electrolytes

In some examples, set forth herein is an ionic liquid electrolyte (ILE) or deep eutectic solvent (DES) including a mixture of a metal halide and an organic compound, wherein water content of the electrolyte is less than 1000 ppm. As used herein, ILE refers to ionic electrolytes which include ionically bonded chemical species. As used herein, DES refers to ionic electrolytes which include ionically bonded chemical species as well as non-ionically bonded chemical species, e.g., species which are bonded through hydrogen-bonds. In some examples, hydrogen bonding in a given DES can dominate (i.e., be stronger) ionic bonding.

In some examples, including any of the foregoing, the ILE or DES includes a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof. In certain examples, the ILE or DES includes alkylimidazolium aluminates. In certain examples, the ILE or DES includes alkylpyridinium aluminates. In certain examples, the ILE or DES includes alkylfluoropyrazolium aluminates. In certain examples, the ILE or DES includes alkyltriazolium aluminates. In certain examples, the ILE or DES includes aralkylammonium aluminates. In certain examples, the ILE or DES includes alkylalkoxyammonium aluminates. In certain examples, the ILE or DES includes aralkylphosphonium aluminates. In certain examples, the ILE or DES includes aralkylsulfonium aluminates. In certain examples, the ILE or DES includes alkylguanidinium aluminates.

In some examples, including any of the foregoing, the ILE or DES includes urea.

In some examples, including any of the foregoing, the metal halide is an aluminum halide.

In some examples, including any of the foregoing, the aluminum halide is AlCl₃.

In some examples, including any of the foregoing, the aluminum halide is AlCl₃, and the organic compound includes: (a) cations selected from the group consisting of N-(n-butyl) pyridinium, benzyltrimethylammonium, 1,2-dimethyl-3-propylimidazolium, trihexyltetradecylphosphonium, and 1-butyl-1-methyl-pyrrolidinium, and (b) anions selected from the group consisting of tetrafluoroborate, tri-fluoromethanesulfonate, and bis(trifluoromethanesulfonyl)imide.

In some examples, including any of the foregoing, the aluminum halide is AlCl₃, and the organic compound is selected from 4-propylpyridine, acetamide, N-methylacetamide, N,N-dimethylacetamide, trimethylphenylammonium chloride, 1-ethyl-3-methylimidazolium bis(trifluoromethylsulfonyl)imide and 1-ethyl-3-methylimidazolium chloride.

The In some examples, including any of the foregoing, the aluminum halide is AlCl₃, and the organic compound is 1-ethyl-3-methylimidazolium chloride.

In some examples, including any of the foregoing, the ILE includes an aluminum halide cation that is datively bonded to the organic compound.

In some examples, including any of the foregoing, the aluminum halide is AlCl₃, and the organic compound is an amide. In some of these examples, the amide is selected from urea, methylurea, ethylurea, and combinations thereof. In certain examples, the amide is urea. In certain examples, the amide is methylurea. In certain examples, the amide is ethylurea.

In some examples, including any of the foregoing, the metal halide is AlCl₃; and the organic compound is selected from 1-ethyl-3-methyl imidazolium chloride, 1-ethyl-3-methylimidazolium bis(trifluoromethylsulfonyl)imide, urea, methylurea, ethylurea, mixtures thereof, and combinations thereof.

In some examples, including any of the foregoing, the ILE includes AlCl₃ and 1-ethyl-3-methyl imidazolium chloride (IL′), the mole ratio of AlCl₃:IL is from 1.1 to 1.7. In some examples the mole ratio is 1.1. In some examples the mole ratio is 1.2. In some examples the mole ratio is 1.3. In some examples the mole ratio is 1.4. In some examples the mole ratio is 1.5. In some examples the mole ratio is 1.6. In some examples the mole ratio is 1.7.

In some examples, including any of the foregoing, the ILE includes a mixture of 1.1 to 1.7 moles AlCl₃, 1.0 mole 1-ethyl-3-methyl imidazolium chloride and 0.1 to 0.5 mole 1-ethyl-3-methylimidazolium bis(trifluoromethylsulfonyl)imide (IL″). In some examples, the mixture includes 1.1, 1.2, 1.3, 1.4, 1.5, 1.6, or 1.7 moles AlCl₃. In some examples, the mixture includes 0.1, 0.2, 0.3, 0.4, or 0.5 moles 1-ethyl-3-methylimidazolium bis(trifluoromethylsulfonyl)imide. In some examples, the mixture includes 0.1, 0.2, 0.3, 0.4, or 0.5 moles 1-ethyl-3-methylimidazolium tetrafluoroborate. In some examples, the mixture includes 0.1, 0.2, 0.3, 0.4, or 0.5 moles 1-ethyl-3-methylimidazolium hexafluorophosphate,

In some examples, including any of the foregoing, the ILE includes AlCl₃ and urea (ILA′). In some examples, including any of the foregoing, the ILE includes AlCl₃ and methylurea (ILA″)

In some examples, including any of the foregoing, the mole ratio of AlCl₃ to ILA′ in the ILE is between 1.1 to 1.7.

In some examples, including any of the foregoing, the mole ratio of AlCl₃ to ILA″ is between 1.1 to 1.7.

In some examples, including any of the foregoing, the ILE is ILA′ and the mole ratio of AlCl₃:urea about 1.1 to about 1.7.

In some examples, including any of the foregoing, the ILE is ILA′ and the mole ratio of AlCl₃:methylurea is about 1.1 to about 1.7.

In some examples, including any of the foregoing, the ILE is ILA′ and the mole ratio of AlCl₃:ethylurea is about 1.1 to about 1.7.

In some examples, including any of the foregoing, the amount of water or hydrochloric acid in the ionic liquid electrolyte is between 0-1000 ppm. In some examples, including any of the foregoing, the amount of water or hydrochloric acid in the ionic liquid electrolyte is less than 1000 ppm. In some examples, including any of the foregoing, the concentration of corrosion products content in the ionic liquid electrolyte is less than 1000 ppm.

Examples of ionic liquids include aluminates, such as ones including, or formed from, a mixture of an aluminum halide and an organic compound. To reduce the water content in the ionic liquid, the organic compound can be subjected to heating and drying under reduced pressure, such as heating in vacuum (e.g., about 10⁻² Torr, about 10⁻³ Torr, or less, and about 70° C.-110° C.) to remove water prior to mixing with an aluminum halide slowly under stirring with cooling to maintain a temperature near room temperature. For example, a suitable ionic liquid can include, or can be formed from, a mixture of an aluminum halide (e.g., AlCl₃) and urea; other aliphatic amides including from 1 to 10, 2 to 10, 1 to 5, or 2 to 5 carbon atoms per molecule, such as acetamide, as well as cyclic (e.g., aromatic, carbocyclic, or heterocyclic) amides, as well as combinations of two or more different amides are contemplated. In some examples, a suitable ionic liquid can include, or can be formed from, a mixture of an aluminum halide (e.g., AlCl₃) and 4-propylpyridine; other pyridines, as well as other N-heterocyclic compounds (including EMIC or EMI) with 4 to 15, 5 to 15, 4 to 10, or 5 to 10 carbon atoms per molecule, as well as combinations of two or more different N-heterocyclic compounds are contemplated. In some examples, a suitable ionic liquid for high temperature operations can include, or can be formed from, a mixture of an aluminum halide and trimethylphenylammonium chloride; other cyclic (e.g., aromatic, carbocyclic, or heterocyclic) compounds including a cyclic moiety substituted with at least one amine or ammonium group, as well as aliphatic and cyclic amines or ammoniums, as well as combinations of two or more different amines or ammoniums are contemplated. In some examples, a suitable organic compounds include N-(n-butyl) pyridinium chloride, benzyltrimethylammonium chloride, 1,2-dimethyl-3-propylimidazolium, trihexyltetradecylphosphonium chloride, and 1-butyl-1-methyl-pyrrolidinium cations with anions such as tetrafluoroborate, tri-fluoromethanesulfonate and bis(trifluoromethanesulfonyl) imide.

In some embodiments, the aluminum halide is AlCl₃, and the organic compound incudes cations selected from N-(n-butyl) pyridinium, benzyltrimethylammonium, 1,2-dimethyl-3-propylimidazolium, trihexyltetradecylphosphonium, and 1-butyl-1-methyl-pyrrolidinium, and anions selected from tetrafluoroborate, tri-fluoromethanesulfonate, and bis(trifluoromethanesulfonyl)imide.

In some embodiments, the aluminum halide is AlCl₃, and the organic compound is selected from 4-propylpyridine, acetamide, trimethylphenylammonium chloride, and 1-ethyl-3-methylimidazolium chloride.

### Protective Covers

In some examples, set forth herein is a protective cover for a metal anode battery, the metal anode battery including: a metal anode, a cathode, a separator, and an ionic liquid electrolyte (ILE); and the protective cover including a fluorinated polymer seal which encapsulates the metal anode, the cathode, the separator, and the ionic liquid electrolyte, and a sealable port for a liquid or gas, wherein the port is transverse to the fluorinated polymer seal.

In some examples, the chemically compatible enclosure has at least three sealed margins. In certain examples, the sealed margins are 1-2 cm in width. In some examples, the chemically compatible enclosure includes a pouch. In certain examples, the dimensions of the pouch are 18 cm×14 cm. In some examples, the sealable port for a liquid or gas is a PP tube which extends through the sealed margin. In some examples, the sealable port for a liquid or gas is a PP tube or a FEP tube which extends through the sealed margin.

### Processes for Making a Rechargeable Battery

Incorporated by reference are the processes for making a rechargeable battery set forth in US 2015-0249261; WO 2015/131132; Lin, M-C, et al., Nature, 2015, p. 1-doi:1038/nature143040; and Angell, et al., PNAS, Early Edition, 2016, p. 1-6, doi:10.1073/pnas.1619795114.

Set forth herein are methods for manufacturing a metal-ion battery including providing an metal anode; providing a cathode; and providing an ionic liquid electrolyte, wherein providing the ionic liquid electrolyte includes: combining an aluminum halide and an organic compound to form an ionic liquid. In some examples, prior to the combining step, the ionic liquid is subjected to vacuum-pumping for about 0.2 hours (h) to about 24 h to remove residual water, hydrochloric acid or organic impurities. In some examples, the vacuum is about 0.1 Torr or less. In some examples, the methods include subjecting the organic compound to heating in vacuum to about 70° C.-110° C. to remove water prior to mixing with the aluminum halide slowly under stirring with cooling to maintain a temperature of about room temperature. In some examples, the methods include providing a separator selected from a porous membrane, such as a glass fiber membrane, a regenerated cellulose membrane, a polyester membrane or a polyethersulfone membrane, or other hydrophobic membrane, such as polyethylene membrane, wherein the porous membrane is optionally further coated with a hydrophilic polymer such as polyacrylic acid and polyvinyl alcohol, and cross-linked by heating.

In some implementations, a reduced content of residual water, HCl and organic impurities can be attained by subjecting the electrolyte, once formed, to a purification procedure. For example, set forth herein, in some examples, are methods for removing HCl in the electrolyte formed by residual water or HCl gas resulting from the residual water by subjecting the electrolyte to reduced pressures, such as under vacuum (e.g., about 0.1 Torr, about 10⁻² Torr, about 10⁻³ Torr, or less) for about 0.2 h to about 24 h or for about 0.5 h to about 24 h, until noticeable bubbling ceases. In some other examples, set forth herein are methods for removing HCl and organic impurities, by adding one or more metal pieces of aluminum foil to the electrolyte, and, after agitation for a period of time, subjecting the electrolyte to reduced pressures, such as under vacuum (e.g., about 0.1 Torr, about 10-2 Torr, about 10-3 Torr, or less) for about 0.2 h to about 24 h at 25-90° C. or for about 0.5 h to about 24 h at 25-90° C. Assembled batteries in some examples are also subjected to vacuum again to remove any residual water and/or acids prior to sealing the battery.

In some examples, set forth herein is a process for making a battery, including the following steps providing a battery set forth herein, and reducing the pressure inside the battery by drawing a vacuum while cycling the battery at least two or more times. The process of reducing the pressure in or around the sealed electrochemical cell removes volatile components by way of vacuum-pumping. In some examples, these volatile components are generated as a consequence of the charge-discharge cycling of the battery.

In some examples, herein, the vacuum-pumping of the electrochemical cell does not just cause water to be removed. By cycling the electrochemical cell while vacuum-pumping, the methods herein remove volatile species which are formed in the electrochemical cell as a side reaction of the cycling process. For example, by cycling the electrochemical cell while vacuum-pumping, the methods herein remove species, such as not limited to, HCl and any proton containing hydrocarbon. In some examples, at least two cycles while vacuum-pumping is used in the methods herein. In some examples, at least ten cycles while vacuum-pumping is used in the methods herein.

In some of these examples, the process removes residual water, hydrochloric acid, organic impurities, or combinations thereof from the electrolyte. In some examples, the process removes side reaction products such as hydrogen at the battery cathode and anode during battery cycling.

In some examples, including any of the foregoing, providing a battery includes forming at least one or more electrochemical cells, each including a metal anode, a cathode, a separator, and an ionic liquid electrolyte (ILE) deep eutectic solvent (DES). In this example, the ILE or DES includes a mixture of a metal halide salt and an organic compound. In some examples, the methods include forming two or more electrochemical cells which are stacked in parallel. In some examples, the methods include forming two or more electrochemical cells which are stacked in series.

In some examples, including any of the foregoing, the methods further include sealing a fluorinated polymer enclosure to encapsulate the at least one or more electrochemical cells. The sealing can be accomplished with an impulse sealer or similar instrument.

In some examples, including any of the foregoing, the methods include reducing the pressure in the battery by drawing a vacuum while cycling the battery at least 30 charge-discharge cycles.

In some examples, including any of the foregoing, the methods include at least 60 or more times.

In some examples, including any of the foregoing, the methods include reducing the pressure to greater than, or equal to, 5 Pascal (Pa) and less than 101,325 Pa. In some examples, the methods include reducing the pressure to at least 5 Pascal (Pa). In some examples, the methods include reducing the pressure to at least 0.1 Torr (13.33 Pa) or less.

In some examples, including any of the foregoing, the methods include cycling at 100 mA/g.

In some examples, including any of the foregoing, the methods include cycling the battery at room temperature between 1 V to 2.4 V.

In some examples, including any of the foregoing, the methods include cycling the battery at room temperature between 2.1 to 2.4 V.

In some examples, including any of the foregoing, the methods include cycling the battery at −20° C. from between 1 to 2.7 V.

In some examples, including any of the foregoing, the methods include cycling the battery at −20° C. from between 2.1 to 2.7 V.

In some examples, including any of the foregoing, the methods include cycling the battery at room temperature and a cut-off voltage between the cathode and anode of 2.4V.

In some examples, including any of the foregoing, the methods include cycling the battery at room temperature and a cut-off voltage between the cathode and anode of 2.7 V.

In some examples, including any of the foregoing, the methods include cycling the battery at temperatures lower than −20° C. and a cut-off voltage between the cathode and anode of 2.7 V.

In some examples, including any of the foregoing, the methods include the cycling the battery at −20° C. and a cut-off voltage up to 2.7V.

In some examples, including any of the foregoing, the metal anode is an Al metal anode and the methods further include polishing the Al metal anode in an inert gas environment prior to the step of providing a battery. This polishing removes any native oxide or surface oxide present on the Al metal anode and thereby improves its electrical contact to that which it is laminated or bonded to.

In some examples, including any of the foregoing, the providing a battery includes first degassing the ionic liquid electrolyte in the battery which is later injected into the battery. In some of these examples, the degassing includes subjecting the organic compound to heating in vacuum to about 60° C. to remove water prior to mixing the organic compound with an aluminum halide slowly under stirring with cooling to maintain a temperature of about room temperature.

In some of these examples, the organic compound is selected from 1-ethyl-3-methylimidazolium chloride, urea, methylurea, and ethylurea. In certain examples, the organic compound is 1-ethyl-3-methylimidazolium chloride, In certain examples, the organic compound is urea. In certain examples, the organic compound is methylurea. In certain examples, the organic compound is ethylurea.

In some examples, including any of the foregoing, the providing a battery includes injecting the ionic liquid electrolyte through a sealable port for a liquid or a gas in a chemically compatible enclosure surrounding the battery or the at one or more electrochemical cells.

In some examples, including any of the foregoing, the methods include monitoring at least one metric selected from current density, voltage, impedance, pressure, temperature and capacity while reducing the pressure in or around the battery by drawing a vacuum while cycling the battery.

In some examples, including any of the foregoing, the methods include sealing the port for a liquid or gas after reducing the pressure in or around the battery by drawing a vacuum while cycling the battery.

In some examples, including any of the foregoing, the methods include reducing the pressure in or around the battery by drawing a vacuum while cycling the battery after the battery has been cycled without reducing the pressure in or around the battery.

In some examples, including any of the foregoing, the methods include reducing the pressure in or around the battery by drawing a vacuum while cycling the battery after the battery has been cycled without reducing the pressure in or around the battery occurs subsequent to measuring a capacity or coulombic efficiency decay during the cycling.

In some examples, also set forth herein is a battery made by a process set forth herein.

In some other examples, set forth herein is a process of making an ionic liquid electrolyte (ILE) or deep eutectic solvent (DES), including the following steps: providing an ILE or DES in a sealed electrochemical cell, wherein the ILE includes a mixture of a metal halide and an organic compound; and reducing the pressure in or around the sealed electrochemical cell by drawing a vacuum while cycling the electrochemical cell at least two or more times. The process of reducing the pressure in or around the sealed electrochemical cell removes volatile components by way of vacuum-pumping. In some examples, these volatile components are generated during the charge-discharge cycling of the battery.

In some of these examples, the process removes residual water, hydrochloric acid, organic impurities, or combinations thereof from the electrolyte. In some examples, the process removes side reaction products such as hydrogen at the battery cathode and anode during battery cycling.

In some examples, including any of the foregoing, the metal anode is an Al metal anode and the methods further include polishing the Al metal anode in an inert gas environment prior to the step of providing a battery. This polishing removes any native oxide or surface oxide present on the Al metal anode and thereby improves its electrical contact to that which it is laminated or bonded to.

In some examples, including any of the foregoing, the providing a battery includes first degassing the ionic liquid electrolyte in a sealed electrochemical cell which is later injected into the battery. In some of these examples, the degassing includes subjecting the organic compound to heating in vacuum to about 60° C. to remove water prior to mixing the organic compound with an aluminum halide slowly under stirring with cooling to maintain a temperature of about room temperature.

In some of these examples, the organic compound is selected from 1-ethyl-3-methylimidazolium chloride, urea, methylurea, and ethylurea. In certain examples, the organic compound is 1-ethyl-3-methylimidazolium chloride. In certain examples, the organic compound is urea. In certain examples, the organic compound is methylurea. In certain examples, the organic compound is ethylurea.

In some examples, set forth herein is a process of making an ionic liquid or deep eutectic solvent electrolyte for rechargeable metal ion battery, the process including providing an ionic liquid electrolyte in an electrochemical cell that is sealed under vacuum; and reducing the pressure in or around the electrochemical cell by drawing a vacuum on or around the ionic liquid electrolyte while cycling the electrochemical cell at least two or more times.

In some examples, set forth herein is an ionic liquid electrolyte made by a process set forth herein.

### Processes for Making an Electrolyte to Use in a Rechargeable Battery

In some examples, an electrolyte is made by first mixing a strong Lewis acid metal halide and Lewis base ligand. For example, the following electrolytes can be made. Generally, the strong Lewis acid metal halide is contacted with a dried Lewis Base ligand. The mixture is heated. Then the mixture is cooled.

For example, set forth herein in certain embodiments is an AlCl₃:Urea electrolyte. In this electrolyte, in some examples, the urea is dried at about 60-80° C. under vacuum for about 24 hours. In some examples, the urea is then transported to the glovebox in a vacuum sealed container. In some examples, if the urea is heated past its melting point, the resulting electrolyte (after mixing with AlCl₃) is viscous, sometimes forming a solid. In some examples, set forth herein is a step wherein AlCl₃ is slowly added to the urea in a glass vial in a mole ratio of about 1.3:1, about 1.5:1, about 1.7:1, or about 2:1 AlCl₃:urea. In some examples, the mixtures are then heated at 60-80° C. to form a liquid product and the cooled to room temperature. In some examples, the AlCl₃:urea mixtures are heated at lower temperatures (e.g., below about 80° C. or between about 30-40° C.).

For example, set forth herein in certain embodiments is an AlCl₃:Acetamide electrolyte. In some examples, the acetamide is dried by heating it to about 100-120° C. while bubbling nitrogen through it. In some examples, the acetamide is then immediately moved to the glovebox. In some examples, set forth herein is a step wherein AlCl₃ is slowly added to the acetamide under constant magnetic stirring in a mole ratio of about 1.5:1 AlCl₃:acetamide. In some examples, the mixture is then heated at 60-80° C. to form a liquid product and the cooled to room temperature. In some examples, the AlCl₃:urea mixtures are heated at lower temperatures (e.g., below about 80° C. or between about 30-40° C.).

Also set forth herein in certain embodiments is an AlCl₃:4-Propylpyridine electrolyte. In some examples, the 4-propylpyridine (TCI, >97%) is dried over molecular sieves for multiple days. In some examples, set forth herein is an additional step wherein AlCl₃ is added slowly under constant magnetic stirring. In certain examples, at about the 1:1 equivalence point, a white solid forms. In some further examples, once a homogenous liquid reaction product has formed and ample time for the 4-propylpyridine to completely react passes (about 24 hours), set forth herein is a step wherein the sampled is dried at about 60-80° C. under vacuum for about 24 hours and transported to the glovebox in a vacuum sealed container. In some examples, set forth herein is a step wherein aluminum foil is added to this electrolyte. In some of these examples, the addition of Al induces a slight color change, which varies depending on the source of aluminum chloride used.

Also set forth herein in certain embodiments is an AlCl₃:Trimethylphenylammonium chloride electrolyte.

In some examples, trimethylphenylammonium chloride (TMPAC) (Sigma Aldrich) is used. In some examples, set forth herein are mixtures with mole ratios of AlCl₃:TMPAC of about 1.7:1 and about 1.3:1 which are made at room temperature by adding TMPAC directly to AlCl₃ under constant magnetic stirring. In some examples, HCl is removed by drying at about 60-80° C. under vacuum for about 24 hours and adding aluminum foil.

In some examples, set forth herein are methods for preparing and purifying an electrolyte such as but not limited to AlCl₃/EMIC, which has a mole ratio of AlCl₃/EMIC of about 1.3:

In certain examples, EMIC is pre-heated at about 70° C. under vacuum in an oven for about 1 day to remove residual water and then immediately moved into a glovebox. In some of these examples, about 1.78 g EMIC is added into an about 20 mL vial at room temperature, followed by slow addition of about 2.08 g AlCl₃ in 4-5 portions, mixing for about 5-10 min during each portion. In certain examples, vigorous stirring is maintained throughout the mixing process. Once all AlCl₃ was dissolved, in some examples, set forth herein is a step in which small Al pieces are added to the electrolyte and stirred overnight at room temperature. Subsequently, the electrolyte is held under vacuum for about 20 min in the anti-chamber of the glovebox. In some examples, the treated electrolyte is then stored in the glovebox for further use.

In some examples, HCl gas resulting from residual water is removed using vacuum (about 10⁻³ Torr) pumping until noticeable bubbling ceases.

In some examples, to remove organic impurities, metallic impurities, aluminum foil (Alfa Aesar, 99%) is added to an electrolyte after removal of the surface oxide layer using sand paper. After stirring overnight at 25-90° C., in some examples, the electrolyte is placed under vacuum once more before addition to the battery, at which point it was a clear liquid.

### Processes for Making a Cathode to Use in a Rechargeable Battery

In some examples, set forth herein are methods of making a cathode suitable for use in a rechargeable battery.

In some embodiments, the cathode includes a metal substrate. In some examples, the metal substrate is a nickel substrate and it includes a protective coating of a carbonaceous material derived from pyrolysis of organic compounds deposited on the metal substrate from solution or gas phase, or a conducting polymer deposited on the metal substrate.

Bare Ni foil or Ni foam can be used as current collectors or the aforementioned substrate. Natural graphite particles can be loaded onto such a Ni-based substrate with a binder. Ni and W are found to be more resistive to corrosion in Al-ion battery than most other metals on the cathode side.

Ni foil or Ni foam can be coated with a carbon or graphite layer by various methods to impart enhanced corrosion resistance. One such method is to grow a carbon or graphitic layer on Ni by coating Ni with a carbon-rich material, such as pitch dissolved in a solvent, and then heating at about 400-800° C. Another protective coating is a conducting polymer layer such as poly(3,4-ethylenedioxythiophene) polystyrene sulfonate (PEDOT:PSS). A graphite/polymer binder can also coat Ni densely and act as a protection layer as well as an active cathode layer.

In some examples, set forth herein are cathodes having polymer binders with graphite particles. For example, a polyacrylic acid (PAA)/polyvinyl alcohol (PVA)-based polymer binder for graphite particles can be used.

In some examples, natural graphite particles are dispersed in water containing about 10 wt % PAA and about 3 wt % PVA and stirred to make a slurry. The slurry is applied to a current collector as described above, at a loading of about 2-20 mg/cm2, followed by drying at about 70-150° C. in vacuum for about 3 hours or longer to thoroughly remove water, leaving graphite particles packed on the current collector to form a cathode for an Al battery. Further, several weight percent of graphite fibers can be added to the slurry to improve electrical conductivity of the cathode.

In some examples, a carboxymethyl cellulose (CMC)/styrene-butadiene rubber (SBR)/graphite fiber-based polymer binder is used with graphite particles.

In some examples, set forth herein are methods which include using natural graphite particles dispersed in a water slurry containing about 10 wt % CMC and about 1 wt % SBR. In some examples, the slurry is applied to a current collector as described above, at a loading of about 2-20 mg/cm², followed by drying at about 70-200° C. in vacuum for about 3 hours or longer to thoroughly remove water, leaving graphite particles packed on the current collector to form a cathode for an Al battery. In some examples, graphite fibers can be added to the slurry to improve electrical conductivity of the cathode.

In some examples, a PEDOT/PSS/graphite fiber-based polymer binder for graphite particles is used.

In some examples, set forth herein are methods which include using natural graphite particles dispersed in water slurry containing about 10 wt % PEDOT and about 1 wt % PSS conducting polymer. In some examples, the slurry is applied to a current collector as described above, at a loading of about 2-20 mg/cm2, followed by drying at about 70-200° C. in vacuum for about 3 hours or longer to thoroughly remove water, leaving graphite particles packed on the current collector to form a cathode for an Al battery. In some examples, graphite fibers can be added to the slurry to improve electrical conductivity of the cathode.

In some examples, an ionic liquid polymer binder for graphite particles is used.

In some examples, set forth herein are methods which include using natural graphite particles are dispersed in a water slurry containing ionic liquid polymer or oligomer. In some examples, the slurry is applied to a current collector as described above, at a loading of about 2-20 mg/cm2, followed by drying at about 70-200° C. in vacuum for about 3 hours or longer to thoroughly remove water, leaving graphite particles packed on the current collector to form a cathode for Al battery.

In some examples, slurries useful with the compositions and methods described herein include the following.

In some examples, a slurry includes about 89 wt % graphite particles (grade 3061)/about 4 wt % CMC/about 2 wt % SBR/about 5 wt % graphite fibers, on ELAT® carbon fiber cloth, 70° C. annealed for about 2 h). In some examples, also included is about 802 mg of 3 wt % Na-CMC gel in de-ionized (DI)water, about 241 mg of 5 wt % SBR dispersed in DI water, about 30 mg of chopped graphite fiber, about 534 mg of graphite (grade 3061), and about 1.2 mL of DI water.

some examples, a slurry includes about 87 wt % graphite particles/about 10 wt % PAA/about 3 wt % PVA, on M30 carbon fiber paper, 130° C. annealed for about 2 h). In some examples, also included is about 225 mg of 25 wt % PAA aqueous solution, about 169 mg of 10 wt % PVA aqueous solution, about 489 mg of graphite particles, and about 0.4 mL of DI water.

### Processes for Making an Electrode and Pouch Cell

In some examples, set forth herein are methods for fabricating an electrode and pouch cell:

An electrode is made, in some examples, by using a small spatula to uniformly coat a slurry onto a substrate (ELAT or M30, about 2 cm²). The electrode is dried on a hot plate at about 100° C. for about 5 min and weighed to evaluate the loading. Afterwards, the electrode is vacuum-annealed for about 2 h at about 70° C. or about 130° C. The heated electrode is immediately weighed to calculate the exact loading and then used to fabricate a pouch cell (electrolyte not yet present). The fabricated pouch was heated at about 70° C. overnight under vacuum and then immediately moved into the glovebox. Finally the pouch was filled by the purified 1.3 ratio electrolyte, held under vacuum for about 2 min in the ante-chamber, and sealed.

In some examples, during manufacturing, graphite particles (or other cathode active material) can be mixed or otherwise combined with a hydrophilic polymer binder along with a suitable solvent (e.g., water) to form a slurry, and the slurry can be coated or otherwise applied to form a cathode material on a current collector. For example, the cathode can be formed by making a slurry of a cathode active material, such as natural graphite particles, dispersed in a hydrophilic polymer binder solution in water, applying the slurry on the current collector, and annealing to a temperature between about 70° C. to about 250° C. in vacuum. In the case of a mixed polymer binder containing PAA and PVA, annealing crosslinks the two polymers to form an extended polymer binder network with high hydrophilicity and binding ability for active cathode materials.

To afford resistance against corrosion when used in the current collector 110, a metal substrate (e.g., Ni foil or Ni foam) can be applied with a protective coating, such as including a carbon-containing (or carbonaceous) material derived from pyrolysis of organic compounds deposited on the metal substrate. For example, a carbon or graphitic layer can be formed on Ni by coating Ni with a carbonaceous material, such as pitch dissolved in a solvent, and then heating at about 400° C. to about 800° C. Another example of a protective coating is a coating of a conducting polymer deposited on the metal substrate, such as PEDOT:PSS. In place of a metal substrate, a carbonaceous or carbon-based substrate can be used as the current collector 110. For example, fibrous, carbon-based substrates can be used as corrosion-resistant current collectors, such as carbon fiber paper (CFP), carbon fiber cloth (CFC), graphite fiber paper, and graphite fiber cloth. A carbon-based current collector can be adhered to a metal (e.g., Ni) tab using a conducting carbon-polymer composite adhesive, and the metal tab can be welded to electrical leads for charge and discharge. A pouch cell can be sealed with the metal tab extending outside the pouch with thermoplastic heat sealer between the tab and the pouch cell.

The current collectors, polymer binders, separators, electrolyte purification and battery fabrication methods developed in this disclosure are generally applicable to aluminum-ion batteries in general for various types of ionic liquid electrolytes, including urea and EMIC based electrolytes.

In some embodiments, the method further includes providing, between the anode and the cathode, a separator selected from a porous membrane, such as a glass fiber membrane, a regenerated cellulose membrane, a polyester membrane or a polyethersulfone membrane, or other hydrophobic membrane, such as polyethylene membrane, wherein the porous membrane is optionally coated with a hydrophilic polymer such as polyacrylic acid and polyvinyl alcohol, and which is cross-linked by heating.

In some embodiments, providing the ionic liquid electrolyte further includes vacuum pumping the ionic liquid electrolyte to further remove water and hydrochloric acid prior to vacuum sealing a battery stack in a container or pouch.

In some embodiments, the method further includes sealing a container or pouch with a carbon-based current collector glued to metal tabs extending outside the container or pouch for electrical wiring.

The electrolyte supports reversible deposition and dissolution (or stripping) of aluminum at the anode, and reversible intercalation and de-intercalation of anions at the cathode. The electrolyte can include an ionic liquid, which can support reversible redox reaction of a metal or a metal alloy included in the anode.

Higher coulombic efficiencies and longer cycle lives can be attained by reducing a content of any residual water, hydrochloric acid (HCl) and organic impurities in the electrolyte for various ionic liquid electrolytes for aluminum-ion batteries in general including EMIC, urea and other organic based ionic liquids. In some examples, a reduced content of residual water, HCl and organic impurities can be attained by subjecting the electrolyte, once formed, to a purification procedure. For example, to remove HCl in the electrolyte formed by residual water, HCl gas resulting from the residual water can be removed by subjecting the electrolyte to reduced pressure, such as under vacuum (e.g., about 0.1 Torr, about 10⁻² Torr, about 10⁻³ Torr, or less) for about 0.2 h to about 24 h or for about 0.5 h to about 24 h, until noticeable bubbling ceases. As another example, to remove HCl and organic impurities, one or more metal pieces (e.g., from an aluminum foil) can be added to the electrolyte, and, after agitation for a period of time, the electrolyte can be subjected to reduced pressure, such as under vacuum (e.g., about 0.1 Torr, about 10-2 Torr, about 10-3 Torr, or less) for about 0.2 h to about 24 h or for about 0.5 h to about 24 h. The battery, such as a pouch cell, including the anode, the cathode, the separator and the electrolyte can be assembled and subjected to vacuum again to remove any residual water and acids prior to sealing the battery.

During manufacturing, graphite particles (or other cathode active material) can be mixed or otherwise combined with a hydrophilic polymer binder along with a suitable solvent (e.g., water) to form a slurry, and the slurry can be coated or otherwise applied to form a cathode material on a current collector. For example, the cathode can be formed by making a slurry of a cathode active material, such as natural graphite particles, dispersed in a hydrophilic polymer binder solution in water, applying the slurry on the current collector, and annealing to a temperature between about 70° C. to about 250° C. in vacuum. In the case of a mixed polymer binder containing PAA and PVA, annealing crosslinks the two polymers to form an extended polymer binder network with high hydrophilicity and binding ability for active cathode materials.

To afford resistance against corrosion when used in the current collector, a metal substrate (e.g., Ni foil or Ni foam) can be applied with a protective coating, such as including a carbon-containing (or carbonaceous) material derived from pyrolysis of organic compounds deposited on the metal substrate. For example, a carbon or graphitic layer can be formed on Ni by coating Ni with a carbonaceous material, such as pitch dissolved in a solvent, and then heating at about 400° C. to about 800° C. Another example of a protective coating is a coating of a conducting polymer deposited on the metal substrate, such as PEDOT:PSS. In place of a metal substrate, a carbonaceous or carbon-based substrate can be used as the current collector 110. For example, fibrous, carbon-based substrates can be used as corrosion-resistant current collectors, such as carbon fiber paper (CFP), carbon fiber cloth (CFC), graphite fiber paper, and graphite fiber cloth. A carbon-based current collector can be adhered to a metal (e.g., Ni) tab using a conducting carbon-polymer composite adhesive, and the metal tab can be welded to electrical leads for charge and discharge. A pouch cell can be sealed with the metal tab extending outside the pouch with thermoplastic heat sealer between the tab and the pouch cell.

The current collectors, polymer binders, separators, electrolyte purification and battery fabrication methods developed in this disclosure are generally applicable to aluminum-ion batteries in general for various types of ionic liquid electrolytes, including urea and EMIC based electrolytes.

### Methods of Using

The batteries described herein are useful for a variety of applications. In some of these applications, a high rate capacity battery is required. Some of these applications include grid-storage applications, uninterrupted power supply applications, home back-up applications, portable devices, and transportation.

Some of the methods herein include vacuum-pumping in combination with electrochemical cycling. In some applications, when a battery is deployed for use in a particular application, the battery may be monitored by, for example, a battery management system (BMS). If the BMS determines that the battery might benefit from additional vacuum-pumping, then a method of vacuum-pumping in combination with electrochemical cycling may be employed while the battery is deployed in an application. Such a method can removes corrosive reaction products which may have accumulated during battery cycling.

In some examples, including any of the foregoing, the methods include monitoring at least one metric selected from current density, voltage, impedance, pressure, temperature and capacity in order to determining if the battery might benefit from additional vacuum-pumping. In some examples, including any of the foregoing, the methods include monitoring current density. In some examples, including any of the foregoing, the methods include monitoring voltage. In some examples, including any of the foregoing, the methods include monitoring impedance. In some examples, including any of the foregoing, the methods include monitoring pressure. In some examples, including any of the foregoing, the methods include monitoring temperature. In some examples, including any of the foregoing, the methods include monitoring capacity.

In the methods described herein the electrochemical cells may be stacked in series or in parallel.

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### EXAMPLES

The Examples herein show how to make and use highly stable Al-ion batteries having an Al-metal anode. In some examples, by using fluorinated materials, e.g., FEP or PTFE, to pack or enclose the battery components, either in a pouch cell or hard container, harmful side reactions between electrolyte and the pouch or container material are minimized or avoided entirely. The Examples herein show that the fluorinated materials are stable during operation of the battery and also that they tolerant a highly acidic electrolyte environment even after long storage times. In some examples, a tube was inserted in the pouch cell enclosing the battery components to provide a conduit for removing by vacuum-pumping water and HCl, which was residually present in the battery's ionic liquid electrolyte as a consequence of its manufacturing, storage or use. The Examples herein show that continuous vacuum-pumping during charge-discharge cycling is critically important for making highly stable batteries which do not show capacity or CE decay (i.e., fade) as a function of charge-discharge cycle number when electrochemically cycled.

Unless stated otherwise to the contrary, the batteries in this example included an Al foil (Zhongzhoulvye Co., Ltd., 0.016-0.125 mm) metal anode. A 3-mm-wide and 0.09-mm-thick nickel tab (MTI, EQ-PLiB-NTA3) was bonded to the battery cathode comprised of natural graphite flake (GP) (Ted Pella, 61-302 SP-1 natural flake) mixed with a sodium alginate binder (Sigma) dried on a carbon fiber paper (CFP) (Mitsubishi, 30 g/m²) as the cathode current collector. Loading of graphite is ˜2-15 mg/cm². SiO₂ glass fiber filter paper (Whatman GF/A) was used as a separator. Aluminum electrodes were washed with acetone and gently scrubbed with a Kimwipes before use.

All electrolytes were made and batteries assembled in an Argon-filled glovebox with less than about 5 ppm water and oxygen in the glovebox. Aluminum Chloride (AlCl₃) (Alfa Aesar, anhydrous 99.9%) was used as received and opened inside the glovebox. 1-ethyl-3-methylimidazolium chloride, urea, and methylurea were vacuum dried at 60-90° C. for 24 hours.

Unless stated otherwise to the contrary, battery cathodes were prepared by depositing a graphite slurry onto a substrate, such as carbon fiber paper (CFP) or a Ni or a W mesh or foil. Graphite was mixed with sodium alginate in a graphite:alginate mass ratio of 95:5. Specifically, 950 mg GP, 50 mg sodium alginate binder, and 2-3 mL distilled water was used as the slurry. After stirring overnight, 5 mg of the slurry per cm² of the cathode substrate (˜7.5 mg total) was loaded onto the cathode substrate (CFP), and the electrode was baked at 80° C. under vacuum overnight. For construction of the pouch cell, a Ni tab was used as a current collector, which was heat-sealed to attach it.

Unless specified to the contrary, all battery components inside a pouch were fixed in place using carbon tape, which was exposed to the electrolyte. The carbon tape was used to secure certain parts of the battery. However, the carbon tapes is not a necessary component and does not need to be present. A partially assembled cell was dried overnight at 80° C. under vacuum and transferred to the glovebox. In the glovebox, two layers of glass fiber filter paper separator (previously dried at 250° C.) and 1.5 g a 1.3:1 mole ratio of an AlCl₃ urea ionic liquid electrolyte.

### Electrolyte Purification—Generally

Prior to injection into an electrochemical cell or battery assembly, hydrochloric acid (HCl) and water were removed from electrolyte mixtures prepared herein. The mixtures were heated (25-90° C.) and placed under vacuum-pumping (about 10-3 Torr) until noticeable bubbling from the mixture ceased.

To remove organic impurities, aluminum foil (Alfa Aesar, 99%) was added to an electrolyte after removing the Al foil's surface oxide layer using sand paper. After stirring overnight, the electrolyte was placed under vacuum at 25-90° C. once more before injecting the electrolyte into the battery. The electrolyte mixture was a clear liquid following this procedure.

### Electrochemical Analysis—Generally

Galvanostatic charge/discharge measurements were performed outside of the glovebox (Vigor Tech). Cyclic voltammetry (CV) measurements were executed on a potentiostat/galvanostat model CHI 760D (CH Instruments) or on a potentiostat/galvanostat model VMP3 (Bio-Logic) in both three-electrode and two-electrode modes. Unless specific to the contrary, discharge/charge cycling was performed at cell voltages of 2.3 to 0.01 V or 2.4 to 1 V and at 100 mAh/g current density on a Battery testing instrument (Neware). The working electrode was an aluminum foil or a GF, the auxiliary electrode included a platinum foil, and an Al foil was used as the reference electrode. All three electrodes were sealed in an enclosure containing AlCl₃:[EMIm]Cl having a mole ratio of about 1.5:1 or 1.7:1 unless specified otherwise. CV measurements were carried out in the laboratory at the ambient environment. The scanning range was set from −1 to 0.85 V (vs. Al) for the Al anode and 0 to 2.5 V (vs. Al) for the graphite cathode, and the scan rate was 10 mV s⁻¹.

Instruments for electrochemical analysis were CHI 760D (CH Instruments), VMP3 (Bio-Logic) and Battery testing instrument (Neware).

### Physical Analysis

For the ex situ XRD study, an Al/Graphite cell (in a Pouch configuration) was charged and discharged at current densities of 50-100 mA/g or 0-100 mA/g (in a Pouch configuration) was charged and discharged at current density measurements were carried out in the laboratory at the ambient environment. The scanning range cathode was removed from the cell in the glove box. To avoid a reaction between the cathode and air/moisture in the ambient atmosphere, the cathode was placed onto a glass slide and then wrapped in Scotch tape. The wrapped samples were immediately removed from the glove box for ex situ X-ray diffraction measurements. Raman spectra measurement was performed to measure the defect band D band intensity relative to the graphite band G band. The data acquisition time was normally 10 s and accumulated for 10 times. The wavelength of laser excitation source was normalized by a silicon wafer at 520 cm-1. A thermoelectrically cooled charge-coupled device with 1,024×256 pixels operating at 60° C. was used as the detector with 1 cm⁻¹ resolution. The laser line was focused onto the sample using an Olympus x 50 objective, and the laser spot size was estimated to be 0.8-1 μm.

Instruments for physical analysis were Bruker D8-advanced (X-ray diffraction measurements) and UniRAM micro-Raman spectrometer with a laser wavelength of 532 μm.

### Example 1—Conventional Pouch Enclosure

This Example shows one of the problems associated with using a conventional aluminum-laminated pouch having a polypropylene (PP) inner-layer as the enclosure for an Al-ion battery.

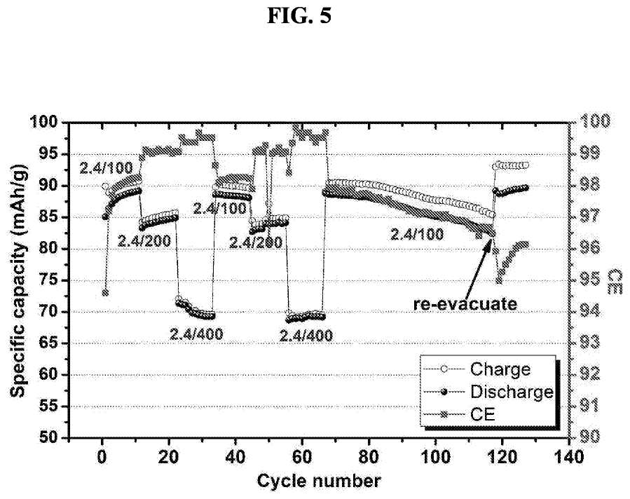

An Al-ion battery was assembled. The battery included the following components. An Al metal anode having dimensions of approximately 4 cm²; a ˜6.25 cm² SiO₂ separator from Whatman (GF/A); a ˜2.25 cm² Ni foil coated with graphite (loading: ˜5 mg/cm²) for the cathode; and an 1.5-2.0 g ionic liquid electrolyte. The Al metal anode was laminated to the separator to form a stack and the pure W (>99%) substrate coated with graphite was then laminated to the Al metal anode and separator stack. The Al-ion battery was hot-sealed in a conventional aluminum-laminated pouch (Showa Denko) having a polypropylene (PP) inner-layer pouch, aluminum foil as the middle layer and polyamide (PA) as the outer-layer. FIG. 5 shows the charge/discharge cycling results of this Al-ion battery. The battery was tested at current densities of 100-400 mA/g and the cut-off charge voltage was set at 2.4V.

As the charge-discharge cycle number increased, the capacity and the coulombic efficiency (CE) decreased (i.e., decayed). Without being bound to theory, the decay was likely due a corrosion producing reaction between the electrolyte and the PP layer of the conventional aluminum-laminated pouch. This corrosion likely generated hydrogen-containing species that converted into hydrogen gas (H₂). The corrosion resulted from a reaction which consumed the ionic liquid electrolyte. In a separate experiment, it was observed that when the ionic liquid electrolyte was added to a conventional aluminum-laminated pouch, not including an Al/graphite cell, the pouch swelled and generated gas which was primarily H₂ gas. In addition, the generated gas led to pouch swelling, breach of the vacuum-seal on the pouch, and further capacity and CE decay. After one-hundred twenty (120) charge-discharge cycles, vacuum pumping was applied to the battery. A tube was inserted into the pouch and a vacuum was pulled through the tube. See FIG. 5 wherein the word “re-evacuate” is recited to indicate this vacuum pumping step at the 120th cycle. This vacuum pumping after 120 cycles removed the generated gas, which lowers the internal resistance of battery. The discharge capacity of the battery recovered back to ˜90 mAh/g, which was similar to the discharge capacity in the beginning of cycling. However, the charge capacity was raised to ˜93 mAh/g, suggesting the gas generation was involved. See FIG. 5 where the discharge capacity increases after the vacuum pumping event. The CE remained low after the vacuum pumping. This example showed that gas was generated during cycling and the low coulombic efficiency <97% was likely due to a corrosive reaction between the electrolyte and PP layer of the conventional aluminum-laminated pouch which generated this gas. See FIG. 5.

### Example 2—Chemically Compatible Enclosure

This Example shows that one of the problems associated with using a conventional aluminum-laminated pouch having a polypropylene (PP) inner-layer as the enclosure for an Al-ion battery is overcome when a chemically compatible enclosure made of FEP, is used in place of the conventional aluminum-laminated pouch having a polypropylene (PP) inner-layer.

An Al-ion battery was assembled. The battery included the following components: An Al anode having dimensions of approximately 4 cm²; a ˜6.25 cm² SiO₂ separator from Whatman (GF/A); a 2.25 cm² Ni substrate coated with graphite for the cathode (loading: ˜5 mg/cm²); and an 1.5-2.0 g ionic liquid electrolyte which included. The Al-ion battery was hot-sealed in a pouch made of a single layer of FEP and having a thickness of 50 micrometer. The FEP pouch was hot-sealed using an impulse-sealer (see FIG. 2).The FEP pouch leave one side open to allow insertion of PP tube. A tube made of PP material was placed on the open side of FEP pouch and one portion of PP tube was placed into the interior of FEP pouch (FIG. 3). The FEP pouch with PP tube was then wrapped by conventional aluminum-laminated film and hot-sealed to form a Al-pouch. Another portion of PP tube extended from Al-pouch (FIG. 4) facilitates to allow filling of electrolyte into FEP pouch and also allowing to pump the pouch during battery charge-discharge cycling. The 1.5-2.0 g ionic liquid electrolyte could be injected directly into the FEP without contacting with conventional aluminum-laminated pouch.

FIG. 2 shows that when FEP is used as the pouch material enclosing the Al-ion battery, a higher CE is observed than when a conventional pouch is used to enclose the Al-ion battery. In this Example, the CE was observed to be greater than 99% for the Al-ion battery having a pouch enclosure made of FEP. At a current density of 100 mA/g and 2.4 V cut-off charge voltage, the CE of the battery having an FEP pouch was significantly better (i.e., CE>99%) than the battery in Example 1 (CE<98%) which had a conventional aluminum-laminated pouch having a polypropylene (PP) inner-layer enclosing the Al-ion battery. The higher CE in this Example indicated that corrosion-inducing side reactions between the electrolyte and the PP pouch were minimized when the FEP enclosure was used in place of the conventional Al-laminated enclosure.

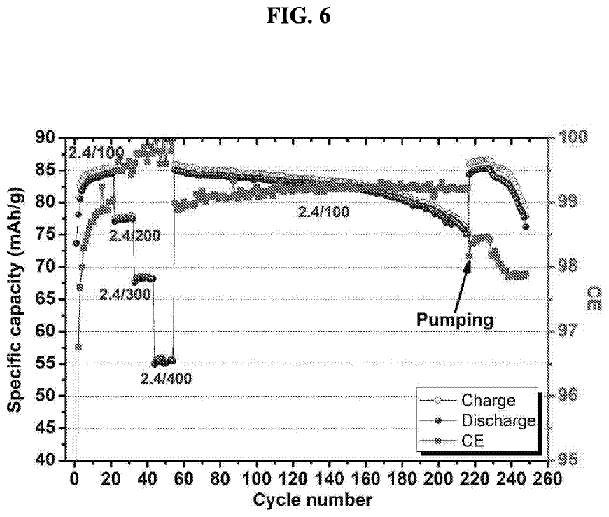

Without being bound to theory, it is likely that the surface of aluminum-laminated pouch in Example 1, which includes laminated layers of a hydrogen-rich polyamide (outside-layer) or polypropylene (inside-layer), reacted with electrolyte in the Al-ion battery which resulted in the generation of H2 gas during charging and discharging. This led to the reduction in capacity and CE. However, as shown in FIG. 6, the reaction between the pouch and the electrolyte was minimized in Example 2. As shown in FIG. 6, the capacity and the CE are not reduced as they were in Example 1 and as shown in FIG. 5.

FIG. 6 shows that the capacity decayed with increasing cycle number, which was likely caused by the generation of gas inside the pouch. This gas generation was likely due to residual water in the electrolyte.

The generated gases inside the pouch were removed by vacuum pumping the pouch cell again at 220th cycle. See FIG. 6 wherein the word “pumping” is recited. After this vacuum pumping event at the 220th cycle, the capacity recovered to the value it was at the beginning of the test. However, the capacity and the coulombic efficiency then decayed after this vacuum pumping event at the 220^{th} cycle. This suggested that gas was continuously being generated in the pouch from the electrolyte, likely due to the presence of, and reaction with, water.

### Example 3—Continuous Pumping and Cycling

This Example shows that one of the problems associated with using a conventional aluminum-laminated pouch having a polypropylene (PP) inner-layer as the enclosure for an Al-ion battery is overcome when a chemically compatible enclosure made of FEP, is used in place of the conventional aluminum-laminated pouch having a polypropylene (PP) inner-layer and continuous vacuum-pumping is used during charging and discharging cycles.

An Al-ion battery was assembled. The battery included the following components: An Al anode having dimensions of approximately 4 cm²; an ˜6.25 cm² SiO₂ separator from Whatman (GF/A); an 2.25 cm² Ni substrate coated with graphite for the cathode (loading: ˜5 mg/cm²); and an 1.5-2.0 g ionic liquid electrolyte which included. The Al-ion battery was hot-sealed in a pouch made of a single layer of FEP and having a thickness of 50 micrometer. The FEP pouch was hot-sealed using an impulse-sealer (see FIG. 2). The FEP pouch leave one side open to allow insertion of PP tube. A tube made of PP material was placed on the open side of FEP pouch and one portion of PP tube was placed into the interior of FEP pouch (FIG. 3). The FEP pouch with PP tube was then wrapped by conventional aluminum-laminated film and hot-sealed to form a Al-pouch. Another portion of PP tube extended from Al-pouch (FIG. 4) facilitates to allow filling of electrolyte into FEP pouch and also allowing to pump the pouch during battery charge-discharge cycling. The 1.5-2.0 g ionic liquid electrolyte could be injected directly into the FEP without contacting with conventional aluminum-laminated pouch.

The battery in this example was vacuum-pumped continuously through a tube which extended through and was sealed to the FEP pouch.

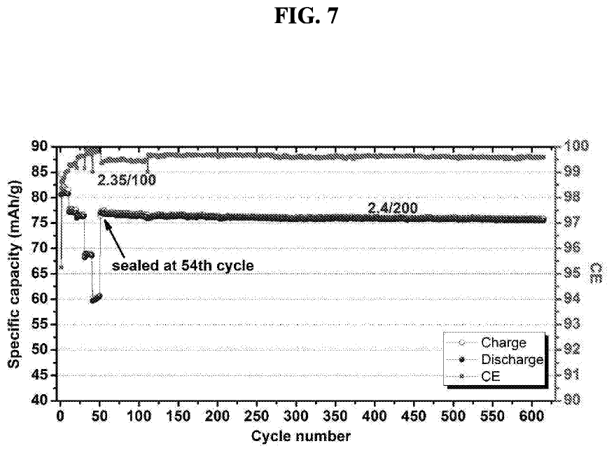

The battery was continuously vacuum-pumped during the first 54 discharge-charge cycles, and then the battery was vacuum sealed at the 54^{th} cycle. See FIG. 7 wherein the phrase “sealed at 54^{th} cycle” is recited. Afterwards, the capacity and CE (˜99.5%) were observed to be stable (i.e., did not decay).

Pumping the battery during its operation could remove the trace amount of water, which would react with electrolyte and forms HCl. Furthermore, the pumping while cycling also removes the products from side reactions which prevents further side reactions. FIG. 7 shows that the battery pumping while cycling at the first 54 cycles and then sealed. It is observed that the coulombic efficiency reached 99.5%, which is the highest among the examples compared here. It is clear to see that the battery after sealing, nearly no decay of coulombic efficiency and capacity after 600 cycling.

See FIG. 7 charge/discharge cycling results of an Al-ion battery with FEP pouch and with continuous vacuum-pumping the pouch for 54 cycles and then sealed.

Batteries with continuous vacuum-pumping for 30-60 cycles demonstrated with almost no decay in performance, in terms of capacity or CE, after thousands of cycles.

### Example 4—Cathode Substrates

This Example shows that the purity of the metallic substrate which is used for cathode current collector is important for making a highly stable Al-ion battery.

Two Al-ion batteries were assembled each having an Al metal anode having dimensions of approximately 4 cm²; a ˜6.25 cm² SiO₂ separator from Whatman (GF/A);1.5-2.0 g ionic liquid electrolyte and a 2.25 cm² cathode current collector coated with graphite. In one battery, the cathode current collector was an impure (purity<99%) W foil. In another battery, the cathode current collector was a pure (purity>99%) W foil. The Al-ion battery was hot-sealed in a pouch made of a single layer of FEP and having a thickness of 50 micrometer. The FEP pouch leave one side open to allow insertion of PP tube. A tube made of PP material was placed on the open side of FEP pouch and one portion of PP tube was placed into the interior of FEP pouch (FIG. 3). The FEP pouch with PP tube was then wrapped by conventional aluminum-laminated film and hot-sealed to form a Al-pouch. Another portion of PP tube extended from Al-pouch (FIG. 4) facilitates to allow filling of electrolyte into FEP pouch and also allowing to pump the pouch during battery charge-discharge cycling. The 1.5-2.0 g ionic liquid electrolyte could be injected directly into the FEP without contacting with conventional aluminum-laminated pouch.

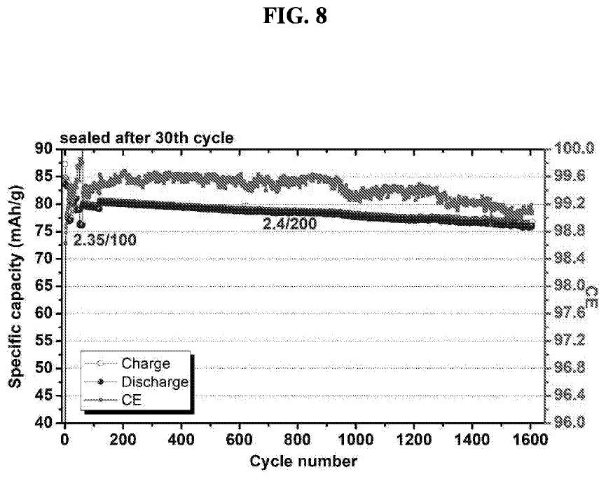

FIG. 8 shows the charge-discharge cycling results for a battery having an impure W foil as substrate for cathode. FIG. 8 shows that the capacity decayed with increasing cycle number. FIG. 8 shows that the CE decayed quickly after 1000 cycles. In FIG. 8, the CE drops from 99.6 to 99.2 after 1600 cycles.

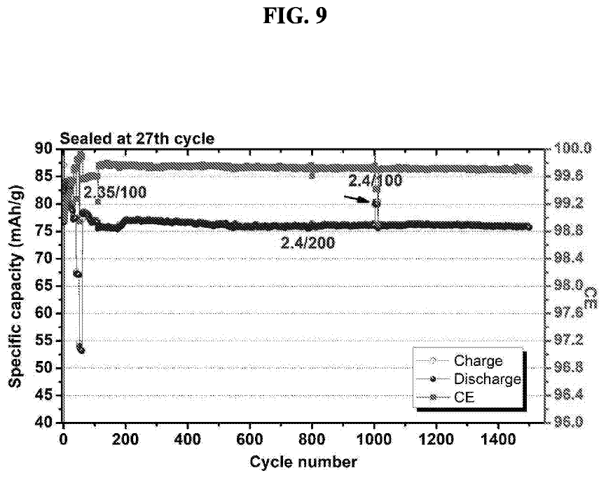

However, when highly pure W foil was used as the current collector, the charge-discharge cycling results improved, as shown in FIG. 9. FIG. 9 shows that the capacity and the CE are stable after 1500 cycles. The results in FIG. 9 suggest that a highly pure W cathode current collector is useful for achieving high CE, also for minimizing side reactions on the metal substrate surface. FIG. 9 shows that the CE is 99.7% for pure W.

See FIG. 8 cyclic performance of battery using impure W foil as substrate for cathode. See FIG. 9 Cyclic performance of battery using high purity of W mesh as substrate for cathode. In related experiments, batteries having Ni foil and mesh cathode current collectors were observed to have stable capacities and CE(s) after 1500 cycles.

### Example 5—High Purity Graphite

High purity (99.99%) natural graphite with 20-45 μm particle size diameter was used for the cathode active material. The cathode was made of 95 wt. % graphite and 5 wt. % polyacrylic latex. The cathode dimensions were 80 mm×100 mm. 20-50 μm-thick Ni foil was used as the substrate without pre-treatment. The graphite loading amount on Ni foil was 7-9 mg/cm². The dimensions of Al anode were 81 mm×101 mm. A 400 μm-thick SiO₂ glass separator with dimensions of 90 mm×110 mm was used. The Al-ion battery was hot-sealed in a pouch made of a single layer of FEP and having a thickness of 50 micrometer. The FEP pouch was hot-sealed using an impulse-sealer (see FIG. 2). The FEP pouch leave one side open to allow insertion of PP tube. A tube made of PP material was placed on the open side of FEP pouch and one portion of PP tube was placed into the interior of FEP pouch (FIG. 3). The FEP pouch with PP tube was then wrapped by conventional aluminum-laminated film and hot-sealed to form a Al-pouch. Another portion of PP tube extended from Al-pouch (FIG. 4) facilitates to allow filling of electrolyte into FEP pouch and also allowing to pump the pouch during battery charge-discharge cycling. The 15-20 g ionic liquid electrolyte could be injected directly into the FEP without contacting with conventional aluminum-laminated pouch.

The following ionic liquid electrolytes were prepared: AlCl₃/EMIC with a mole ratio of 1.5-1.7; AlCl₃/Urea with a mole ratio of 1.3, and also AlCl₃/Methylurea with a mole ratio of 1.5. The batteries were tested at room temperature. The current density was 100-400 mA/g.

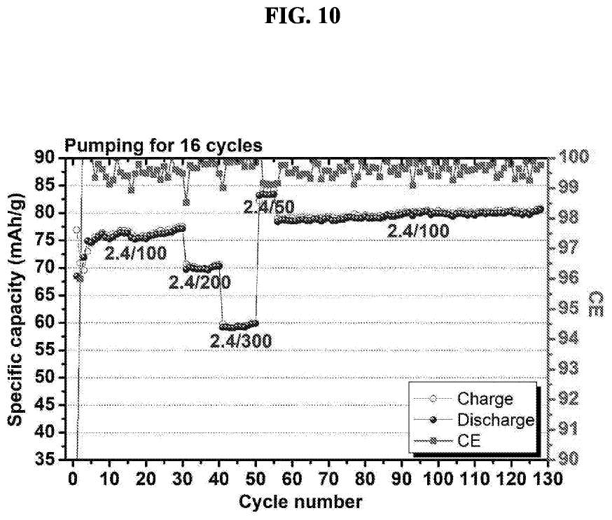

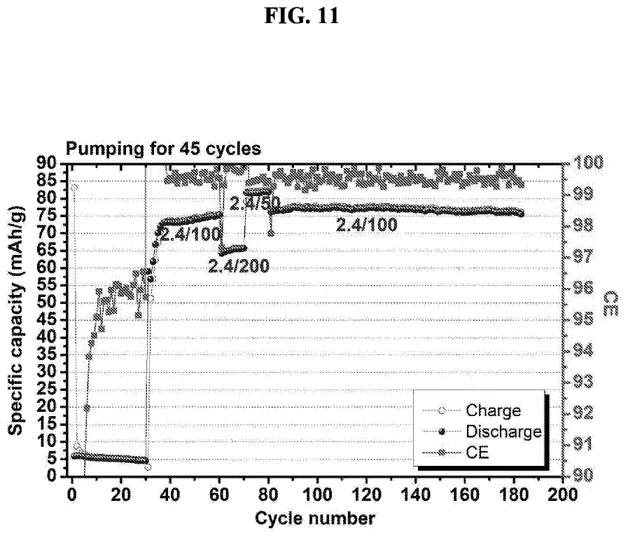

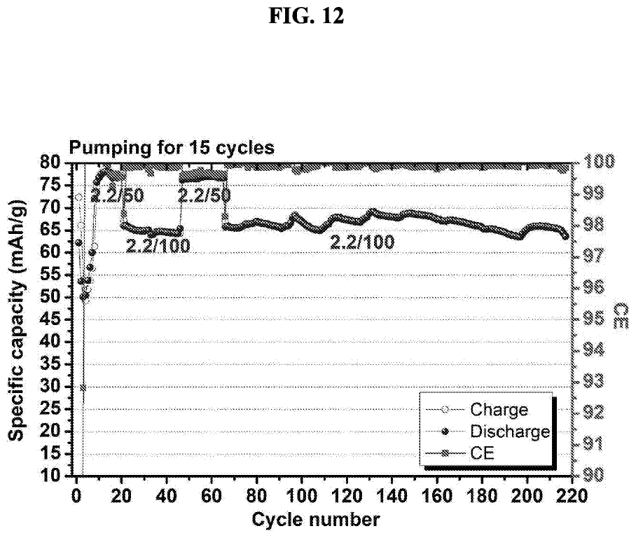

The results herein show that the Al-ion battery with high purity (99.99%) graphite (20-45 μm in diameter) cathode exhibited stable cycling and CE with a range of electrolytes. See FIGS. 10-12.

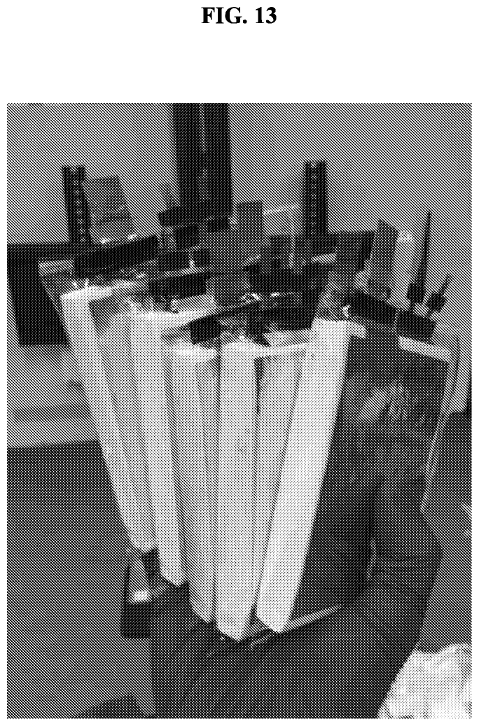

The 1 Ah batteries used in this Example are shown in FIG. 13.

To prepare the 1Ah batteries, a cathode pre-wetting was performed wherein the cathode was wet by a processed electrolyte. This cathode pre-wetting process included using an excess amount (e.g., 80-200 g) of an ionic liquid electrolyte and injecting this excess amount into battery pouch. Next, the process included charging and discharging the battery for at least one cycle. After the charging and discharging cycle, electrolyte has fully infiltrated into the graphite layer in the cathode, and the excess amount of electrolyte (˜20-40 g) was removed using a vacuum-pump to complete the pre-wetting process.

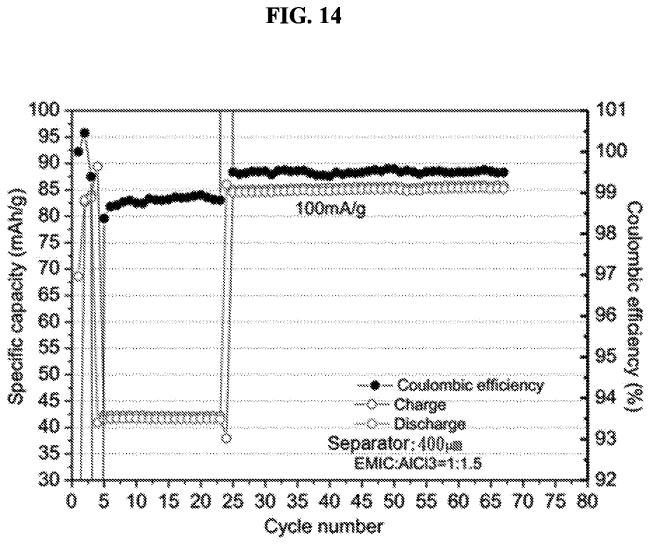

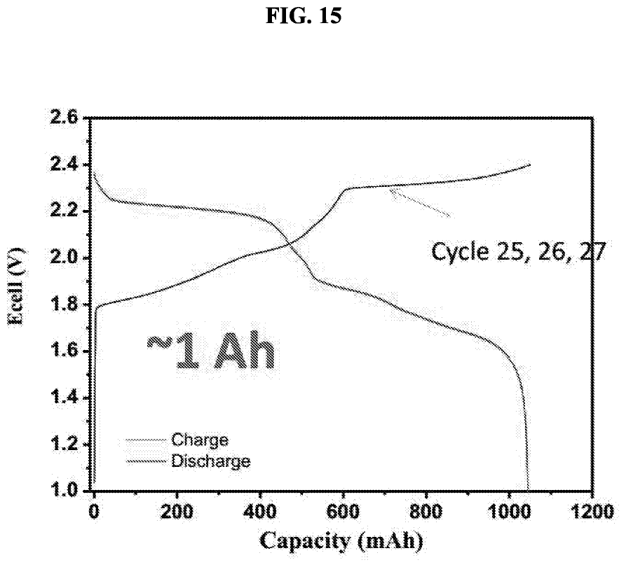

The charge/discharge cycling stability of the 1 Ah battery are shown in FIGS. 14-15. These batteries demonstrated 1 Ah capacity with 99.5% CE.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. A battery, comprising:
a metal anode,
a cathode,
a separator between the metal anode and the cathode,
an ionic liquid electrolyte (ILE) or deep eutectic solvent electrolyte (DES) comprising a metal halide salt and an organic compound in direct contact with the metal anode, the cathode, and the separator,
a chemically compatible enclosure in direct contact with the ILE or DES and encapsulating the metal anode, the cathode, and the separator, and
wherein the chemically compatible enclosure comprises a material selected from the group consisting of a hydrophobic polymer, a fluorinated polymer, an aluminum metal, a fluorinated polymer coated pouch, and a fluorinated polymer coated container.

2. The battery of claim 1, wherein the chemically compatible enclosure further comprises a sealable port for a liquid or gas sealed to the chemically compatible enclosure.

3. The battery of claim 1, wherein the material selected from the group consisting of a hydrophobic polymer, a fluorinated polymer, an aluminum metal, a fluorinated polymer coated pouch, and a fluorinated polymer coated container is in direct contact with the ILE or DES.

4. The battery of claim 1, wherein the chemically compatible enclosure comprises a fluorinated polymer, wherein the fluorinated polymer has a thickness of about 1 μm-1000 μm.

5. The battery of claim 1, wherein the ILE or DES does not wet the innermost wall of the chemically compatible enclosure.

6. The battery of claim 1, wherein the chemically compatible enclosure comprises a pouch.

7. The battery of any one of claim 1, wherein the chemically compatible enclosure is a container made of a fluorinated polymer, aluminum, or fluorinated polymer coated aluminum.

8.-9. (canceled)

10. The battery of claim 1, wherein the fluorinated polymer is selected from fluorinated ethylene propylene (FEP), polytetrafluoroethylene (PTFE), polyvinylidene fluoride (PVDF), hexafluoropropylene (HFP), PVDF-HFP, and combinations thereof.

11. The battery of claim 10, wherein the fluorinated polymer is FEP.

12. The battery of claim 1, wherein the chemically compatible enclosure comprises Al metal.

13. (canceled)

14. The battery of claim 1, wherein the chemically compatible container is a pouch housing the metal anode, the cathode, the separator, and the ILE or DES electrolyte.

15. The battery of claim 14, wherein the pouch is surrounded by a rigid housing.

16. The battery of claim 1, wherein the sealable port for a liquid or gas comprises a FEP tube, a PP tube, a polyethylene tube, a metal tube or a combination thereof.

17.-20. (canceled)

21. The battery of claim 1, wherein the sealable port for a liquid or gas comprises a FEP tube and the chemically compatible enclosure is a fluorinated polymer selected from FEP.

22. The battery of claim 1, wherein the metal anode is Al.

23. The battery of claim 1, wherein the cathode comprises carbon selected from the group consisting of natural graphite and synthetic graphite.

24.-25. (canceled)

26. The battery of claim 1, wherein the battery further comprises a cathode current collector selected from the group consisting of a metal substrate, a glassy carbon, carbon fiber paper, carbon fiber cloth, graphite fiber paper, and graphite fiber cloth.

27. (canceled)

28. The battery of claim 26, wherein the cathode current collector is a metal substrate is a mesh or a foil selected from the group consisting of a Ni foil, a Ni mesh, a W foil, and a W mesh.

29.-30. (canceled)

31. The battery of claim 1, wherein cathode comprises a polymer binder and a cathode active material blended with the polymer binder.

32.-34. (canceled)

35. The battery of claim 1, wherein the ILE comprises 1-ethyl-3-methylimidazolium chloride.

36. The battery of claim 1, wherein the ILE comprises a mixture of a metal halide and an organic compound.

37. The battery of claim 36, wherein the metal halide is AlCl₃, and the organic compound comprises:
(a) cations selected from the group consisting of 1-ethyl-3-methyl imidazolium, N-(n-butyl) pyridinium, benzyltrimethylammonium, 1,2-dimethyl-3-propylimidazolium, trihexyltetradecylphosphonium, 1-butyl-1-methyl-pyrrolidinium, and combinations thereof; and
(b) anions selected from the group consisting of chloride, tetrafluoroborate, tri-fluoromethanesulfonate, hexafluorophosphate, bis(trifluoromethanesulfonyl)imide, and combinations thereof.

38. (canceled)

39. The battery of claim 36, wherein:
the metal halide is AlCl₃; and
the organic compound is selected from the group consisting of 1-ethyl-3-methyl imidazolium chloride, 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, urea, methylurea, ethylurea, mixtures thereof, and combinations thereof.

40. The battery of claim 1, wherein the cathode is infiltrated with an ionic liquid electrolyte which has been electrochemically cycled under vacuum for at least one electrochemical cycle.

41. The battery of claim 1, comprising:
an Al metal anode,
Al current collector having an Al tab,
a SiO₂ glass fiber separator,
a cathode comprising graphite on Ni foil,
and a Ni, W, or C current collector having a Ni, W, or C tab.

42. A process of forming an electrolyte in a battery, comprising the following steps providing a battery comprising:
a metal anode,
a cathode,
a separator between the metal anode and the cathode,
an ionic liquid electrolyte (ILE) or deep eutectic solvent electrolyte (DES) comprising a metal halide salt and an organic compound in direct contact with the metal anode, the cathode, and the separator,
a chemically compatible enclosure in direct contact with the ILE or DES and encapsulating the metal anode, the cathode, and the separator, and
a sealable port for a liquid or gas sealed to the chemically compatible enclosure;
wherein the chemically compatible enclosure comprises a material selected from the group consisting of a hydrophobic polymer, a fluorinated polymer, an aluminum metal, a fluorinated polymer coated pouch, and a fluorinated polymer coated container, and
reducing the pressure inside the battery by drawing a vacuum while cycling the battery at least two or more times.

43.-61. (canceled)

62. A process of making an ionic liquid electrolyte (ILE), comprising the following steps:
providing an ILE in a sealed chemically compatible enclosure comprises a material selected from the group consisting of a hydrophobic polymer, a fluorinated polymer, an aluminum metal, a fluorinated polymer coated pouch, and a fluorinated polymer coated container, wherein the ILE comprises a mixture of a metal halide and an organic compound; and
reducing the pressure in or around the sealed electrochemical cell by drawing a vacuum while cycling the electrochemical cell at least two or more times.

63.-70. (canceled)
